(19) United States
(12) Patent Application Publication
(10) Pub. No.: US 2022/0004704 A1
(43) Pub. Date: Jan. 6, 2022

(54) METHODS FOR DOCUMENTING MODELS, AND RELATED SYSTEMS AND APPARATUS

(71) Applicant: DataRobot, Inc., Boston, MA (US)

(72) Inventors: Gregory Michaelson, Charlotte, NC (US); Michael Seph Mard, Charlotte, NC (US); Scott Lindeman, Brookline, MA (US); David Cade, Wakefield, MA (US); Nikita Striuk, Kyiv (UA); Gianni Saporiti Bracho, Marietta, GA (US); Wesley Hedrick, Columbus, OH (US); Kent Borg, Somerville, MA (US)

(21) Appl. No.: 17/200,596

(22) Filed: Mar. 12, 2021

Related U.S. Application Data
(60) Provisional application No. 62/989,555, filed on Mar. 13, 2020.

(51) Int. Cl. G06F 40/186; G06F 16/93; G06N 5/04; G06F 3/0484

(52) U.S. Cl. CPC G06F 40/186; G06F 3/04842; G06N 5/04; G06F 16/93

(57) ABSTRACT

Methods for automatically generating documentation for a computer-implemented model are provided. In some embodiments, automatically generating documentation for a computer-implemented model includes receiving user input indicative of selection of the computer-implemented model, receiving user input indicative of selection of a documentation template including synthetic content placeholders, and automatically generating documentation for the computer-implemented model by automatically generating synthetic content for each of the synthetic content placeholders based on one or more characteristics of the computer-implemented model, and automatically populating the synthetic content placeholders with the synthetic content.

### CROSS-REFERENCE TO RELATED APPLICATIONS

This application claims priority to and benefit of U.S. Provisional Application No. 62/989,555, titled “Methods for Documenting Models, and Related Systems and Apparatus,” which was filed under Attorney Docket No. DRB-012PR on Mar. 13, 2020 and is hereby incorporated by reference in its entirety.

### FIELD OF THE DISCLOSURE

The present disclosure relates generally to techniques for automatically generating documentation for computer-implemented models.

### BACKGROUND

Computer-implemented models play an important role in everyday life. For instance, computer-implemented models can be used to generate predictions for making critical decisions related to, for example, the likelihood that a person will commit a future crime, trustworthiness for a loan approval, and a medical diagnosis. However, computer-implemented models, and predictions generated by the models, can include various biases based on, for example, gender, geographic location, race, and the like, which can have a negative impact on persons who are directly affected by decisions that are made based on the predictions. Thus, particularly when these models are automated and impact human lives, industries and governments sometimes enact regulations that require that computer-implemented models that are used to make decisions demonstrate compliance with certain standards set forth in these regulations.

In many cases, documentation of computer-implemented models can be provided to regulatory bodies to demonstrate compliance of the models with regulatory standards. For example, computer-implemented models used in the banking industry generally undergo a rigorous regulatory review and compliance process, which relies on detailed and robust model documentation. As another example, computer-implemented pricing models used by insurance companies are generally approved by governmental insurance regulators prior to deployment, based on model documentation.

Documentation of computer-implemented models can also be useful in other circumstances aside from demonstrating regulatory compliance. For example, consulting and professional service organizations may provide computer-implemented model documentation to a client as a deliverable. As another example, an engineering team might utilize documentation of computer-implemented models as a means to summarize model development progress for stakeholders in a repeatable and easily-consumable fashion. As yet another example, documentation can be utilized to quickly summarize the key features of a computer-implemented model to share with colleagues for review and feedback.

### SUMMARY

Despite the usefulness, and in some cases the necessity, of computer-implemented model documentation, the current standard method for creating computer-implemented model documentation is to manually research and write documentation for the computer-implemented model. This manual documentation process is typically performed by a developer of the computer-implemented model, whose time can be an expensive resource. Additionally, because modeling processes are often long and complex, the corresponding documentation is also often long and complex to ensure that sufficient information is available for auditors to review. For instance, documentation of a single computer-implemented model often includes at least 50 pages of technical content, and manual generation of such documentation generally requires approximately 3-6 months to complete. Even further, in addition to documenting a given computer-implemented model under review, in some cases, one or more benchmark models also undergo the same documentation process to enable comparison of the model under review with the benchmark model(s), thereby multiplying the documentation burden several-fold. Therefore, the standard solution for creation of computer-implemented model documentation is laborious, time-consuming, and expensive.

On top of these challenges incurred during documentation of a single computer-implemented model, it is not uncommon for large organizations with complex processes to maintain hundreds or thousands of unique computer-implemented models, each having distinct documentation. These computer-implemented models can be purposed for a wide variety of different use cases, and as such can be subject to different documentation guidelines. For instance, documentation of a computer-implemented model purposed for a particular use case may be required to conform to one of many different standardized formats, each of which can be tedious to configure. Additionally, many different personnel may be responsible for documenting the computer-implemented models. In such cases, the format, style, and content of model documentation is often subject to the whim of the responsible documenter. As a result, computer-implemented model documentation can vary widely according to the responsible documenter. As one example, documentation file type may vary across computer-implemented models. For instance, some documenters may store model documentation in LaTeX file format, while others may store model documentation in MS Word file format. As another example, the quality of model documentation can vary based on the sophistication of the documenting personnel.

As a result of these many sources of variance throughout the computer-implemented model documentation process, computer-implemented model documentation can vary widely across computer-implemented models, resulting not only in a non-standardized and inefficient model documentation process, but furthermore resulting in inefficient review and evaluation of completed documentation. For instance, storage of computer-implemented model documentation in a variety of different formats, file types, locations, and/or programming languages can render the model review process unnecessarily complex and inefficient for documentation auditors.

To alleviate this array of challenges presented by current methods for computer-implemented model documentation, this disclosure provides an automated, standardized but customizable, method for computer-implemented model documentation.

Specifically, this disclosure provides improved methods for computer-implemented model documentation. One method disclosed herein provides for automatic generation of computer-implemented model documentation.

In general, one innovative aspect of the subject matter described in this specification can be embodied in an automated computer-implemented model documentation generation method comprising receiving, via a graphical user interface, user input indicative of selection of the computer-implemented model and user input indicative of selection of a documentation template. The documentation template includes synthetic content placeholders. The method further comprises automatically generating the documentation for the computer-implemented model, by automatically generating synthetic content for each of the synthetic content placeholders based on one or more characteristics of the computer-implemented model, and automatically populating the synthetic content placeholders with the respective synthetic content.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. In some embodiments, the computer-implemented documentation is generated following development of the computer-implemented model. In alternative embodiments, the computer-implemented model documentation is generated during development of the computer-implemented model.

In some embodiments, the documentation template is selected from a database storing a plurality of documentation templates. In some embodiments, the documentation template is a new documentation template created by the user via the graphical user interface prior to selection or is an existing documentation template edited by the user via the graphical user interface prior to selection. Creation and editing of the documentation template can at least in part include selection of at least one of the synthetic content placeholders for inclusion in the documentation template. In some embodiments, the documentation template can further include static content placeholders. In such embodiments, automatically generating the documentation for the computer-implemented model further can include automatically identifying static content for each of the static content placeholders based on one or more characteristics of the computer-implemented model, and automatically populating the static content placeholders with the respective static content.

In some embodiments, the synthetic content can include validation and/or cross-validation performance scores for the computer-implemented model. In such embodiments, automatically generating the synthetic content can include automatically generating the validation and/or cross-validation performance scores for the computer-implemented model. Automatically generating the validation and/or cross-validation performance scores for the computer-implemented model can include generating the validation performance score for the computer-implemented model based on a proportion of correct predictions generated by the computer-implemented model on a portion of a training dataset held-out from training the computer-implemented mode, and/or generating the cross-validation performance score for the computer-implemented model based on a proportion of correct predictions generated by the computer-implemented model on each portion of a pluraity of portions of the training dataset used to train the computer-implemented model.

In some embodiments, the synthetic content can include a list of features of data samples processed by the computer-model, where each feature in the list of features is ranked according to a respective feature impact score. In such embodiments, automatically generating the synthetic content can include automatically determining the respective feature impact score for each feature and automatically ranking the features in the list of features according to the determined feature impact scores. Automatically determining the respective feature impact score for each feature can include automatically determining a contribution of the feature to one or more predictions generated by the computer-implemented model.

In some embodiments, the synthetic content can include text summarizing an explanation for predictions generated by the computer-implemented model. In such embodiments, automatically generating the synthetic content can include automatically generating the text. Automatically generating the text summarizing the explanation for predictions generated by the computer-implemented model can further include automatically determining a respective feature impact score for each feature in a list of features of data samples processed by the computer-model, the respective feature impact score for each feature indicating a contribution of the feature to the predictions generated by the computer-implemented model, and automatically generating text describing the respective feature impact score for each feature in the list of features.

By taking the special nuances of computer-implemented model documentation into account as described above and throughout the remainder of this disclosure, the invention can enable more efficient and more accurate computer-implemented model documentation.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

These and other features, aspects, and advantages of the present invention will become better understood with regard to the following description, and accompanying drawings, where:

FIG. 1 is a block diagram of a system environment for a computer-implemented model documentation system configured to generate documentation for a computer-implemented model, in accordance with an embodiment.

FIG. 2 is a block diagram of an architecture of a computer-implemented model documentation system configured to automatically generate documentation for computer-implemented models, in accordance with an embodiment.

FIG. 3 is a block diagram of a system environment in which a computer-implemented model documentation system operates, in accordance with an embodiment.

FIG. 4 is a flow chart of a method for automated generation of computer-implemented model documentation, in accordance with an embodiment.

FIG. 5 is an exemplar graphical representation of a development blueprint for a computer-implemented model, in accordance with an embodiment.

FIG. 6 is an exemplar graphical representation of a percentage of data samples held-out from training of a computer-implemented model for validation of the computer-implemented model, in accordance with an embodiment.

FIG. 7 is a graphical representation depicting exemplar performance scores for each fold of a 5-fold cross-validation performed for a computer-implemented model, in accordance with an embodiment.

FIG. 8 is a graphical representation depicting exemplar validation and cross-validation performance scores generated for a computer-implemented model, in accordance with an embodiment.

FIG. 9 is a graphical representation that depicts exemplar values used to generate a confusion matrix for a computer-implemented model, in accordance with an embodiment.

FIG. 10 is an exemplar lift chart for a computer-implemented model, in accordance with an embodiment.

FIG. 11 is an exemplar ROC curve for a computer-implemented model, in accordance with an embodiment.

FIG. 12 is an exemplar prediction distribution graph for a computer-implemented model, in accordance with an embodiment.

FIG. 13 is a graphical representation depicting an exemplar list of features included in data samples on which a computer-implemented model bases predictions, in accordance with an embodiment.

FIG. 14 is an exemplar graphical representation of the normalized feature impact scores for the features of FIG. 13 having the highest feature impact scores, in accordance with an embodiment.

FIG. 15 is a partial dependence plot for the feature of FIGS. 13 and 14 labeled as “annual inc”, in accordance with an embodiment.

FIG. 16 is a partial dependence plot for the feature of FIGS. 13 and 14 labeled as “int rate”, in accordance with an embodiment.

FIG. 17 is a partial dependence plot for the feature of FIGS. 13 and 14 labeled as “grade”, in accordance with an embodiment.

FIG. 18 is an exemplar graphical representation of a feature associations matrix, in accordance with an embodiment.

FIG. 19 is a graphical representation of exemplar validation performance scores, cross-validation performance scores, and sample percentages generated for a plurality of benchmark models, in accordance with an embodiment.

FIG. 20 is a screen shot of an example graphical user interface of a computer-implemented model documentation system, in accordance with an embodiment.

FIG. 21 is a screen shot of an example graphical user interface of a computer-implemented model documentation system, in accordance with an embodiment.

FIG. 22 is a screen shot of an example graphical user interface of a computer-implemented model documentation system, in accordance with an embodiment.

FIG. 23 is a screen shot of an example graphical user interface of a computer-implemented model documentation system, in accordance with an embodiment.

FIG. 24 is a screen shot of an example graphical user interface of a computer-implemented model documentation system, in accordance with an embodiment.

FIG. 25 illustrates an example computer for implementing the methods described herein (e.g., in FIGS. 1-25), in accordance with an embodiment.

The figures depict various embodiments for purposes of illustration only. One skilled in the art will readily recognize from the following discussion that alternative embodiments of the structures and methods illustrated herein can be employed without departing from the principles of the invention described herein.

### DETAILED DESCRIPTION

### I. Terms

In general, terms used in the claims and the specification are intended to be construed as having the plain meaning understood by a person of ordinary skill in the art. Certain terms are defined herein to provide additional clarity. In case of conflict between the plain meaning and the provided definitions, the provided definitions are to be used.

Any terms not directly defined herein shall be understood to have the meanings commonly associated with them as understood within the art of the invention. Certain terms are discussed herein to provide additional guidance to the practitioner in describing the compositions, devices, methods and the like of aspects of the invention, and how to make or use them. It will be appreciated that the same thing can be said in more than one way. Consequently, alternative language and synonyms can be used for any one or more of the terms discussed herein. No significance is to be placed upon whether or not a term is elaborated or discussed herein. Some synonyms or substitutable methods, materials and the like are provided. Recital of one or a few synonyms or equivalents does not exclude use of other synonyms or equivalents, unless it is explicitly stated. Use of examples, including examples of terms, is for illustrative purposes only and does not limit the scope and meaning of the aspects of the invention herein.

The term “approximately” and other similar phrases as used in the specification and the claims, should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language related to “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, related to “only one of” or “exactly one of,” or, when used in the claims, “consisting of” will refer to the inclusion of exactly one element of a number or list of elements. In general, the term “or” as used shall only be interpreted as indicating exclusive alternatives (i.e. “one or the other but not both”) when preceded by terms of exclusivity, related to “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms related to “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

### II. Automated Model Documentation System Overview

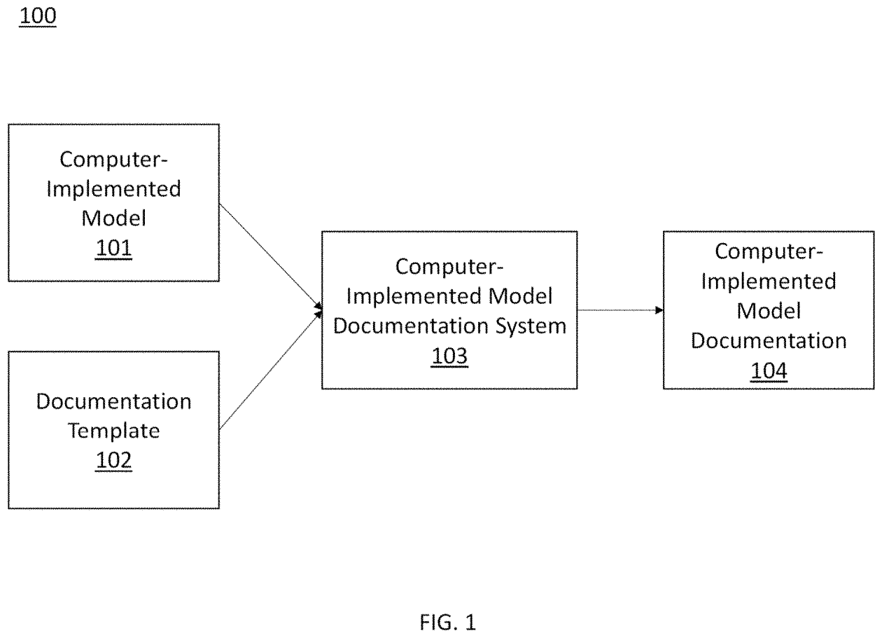

FIG. 1 is a block diagram of a system environment 100 for a computer-implemented model documentation system 103 configured to generate documentation for a computer-implemented model, in accordance with an embodiment. As shown in FIG. 1, the computer-implemented model documentation system 103 obtains (e.g., receives) a computer-implemented model 101 and a documentation template 102, and generates computer-implemented model documentation 104 for the computer-implemented model 101 using the documentation template 102.

As referred to herein, the term “computer-implemented model” may refer to any model that is at least in part implemented by a computer system. For example, a computer-implemented model can be a machine-learning model that is at least in part developed (e.g., trained and/or validated) and/or deployed (e.g., used) by a computer system. In some embodiments, a machine-learning model can be a predictive model. Exemplary embodiments of a computer-implemented model can include a decision tree, a support vector machine model, a regression model, a boosted tree, a random forest, a neural network, a deep learning neural network, a k-nearest neighbor model, and a naive Bayes model. Computer-implemented models are at least in part implemented by computer systems because, in general, it would be too difficult or too inefficient for the models to be developed or deployed by a human, at least due to the size and/or complexity of an associated dataset.

As referred to herein, the term “documentation” with regard to a computer-implemented model may refer to an organized (e.g., structured) summary of content characterizing the computer-implemented model. In some embodiments, computer-implemented model documentation can be organized according to guidelines provided by a particular entity, for example, a regulatory body. Embodiments of computer-implemented model documentation content are discussed in further detail below.

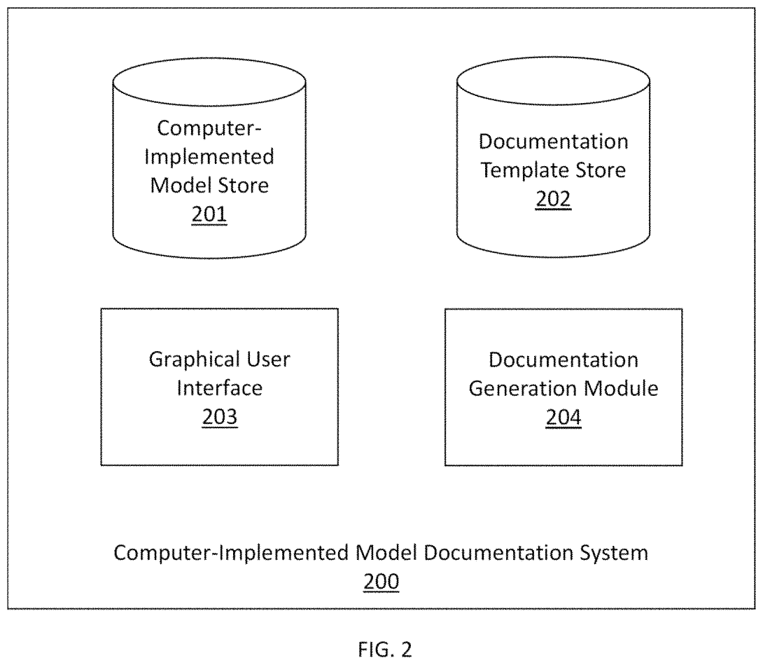

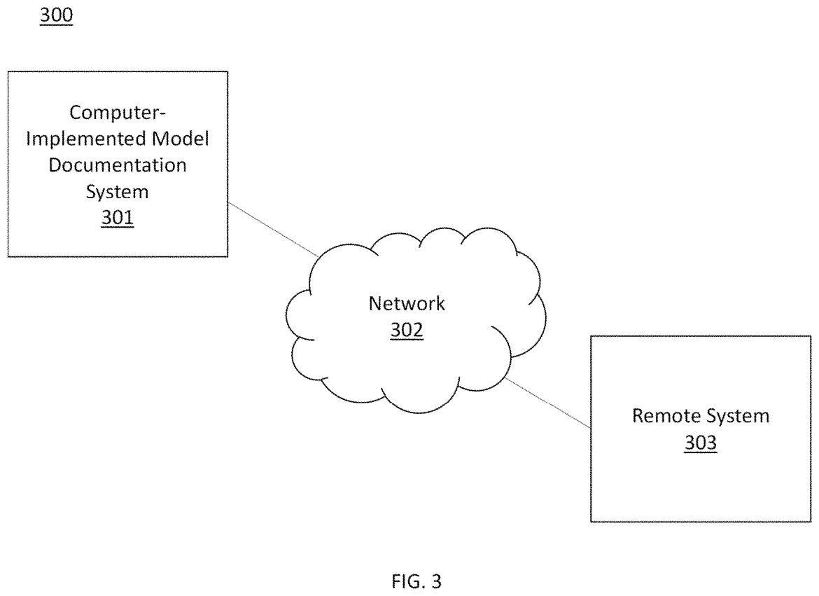

The computer-implemented model 101 can be obtained by the computer-implemented model documentation system 103 from any source. For instance, in some embodiments, the computer-implemented model 101 can be received by a component of the computer-implemented model documentation system 103 from another component of the computer-implemented model documentation system 103. Specifically, as discussed in further detail with regard to FIG. 2, the computer-implemented model 101 can be stored in and received from a computer-implemented model store within the computer-implemented model documentation system 103. In alternative embodiments discussed in further detail with regard to FIG. 3, the computer-implemented model can be received by the computer-implemented model documentation system 103 from a source external to the computer-implemented model documentation system 103. Specifically, the computer-implemented model 101 can be received from a remote system (e.g., a third-party system). As discussed in further detail below with regard to FIG. 2, in some embodiments, the computer-implemented model 101 can be selected for documentation by a user via a graphical user interface.

Furthermore, the computer-implemented model 101 can be documented by the computer-implemented model documentation system 103 at any one or more phases of development (e.g., training and/or validation) and/or deployment (e.g., use) of the computer-implemented model 101. In some embodiments in which the computer-implemented model documentation system 103 has access to the computer-implemented model 101 during the development of computer-implemented model 101, the computer-implemented model 101 can be documented by the computer-implemented model documentation system 103 during development of the computer-implemented model 101. For example, the computer-implemented model 101 can be documented simultaneously by the computer-implemented model documentation system 103 during development of the computer-implemented model 101. As another example, the computer-implemented model 101 can be intermittently documented by the computer-implemented model documentation system 103 at specific points throughout the development of the computer-implemented model 101.

In some additional embodiments, the computer-implemented model 101 can be documented by the computer-implemented model documentation system 103 following development of the computer-implemented model 101. This capability of the computer-implemented model documentation system 103 to document the computer-implemented model 101 following development is particularly useful in cases in which the computer-implemented model documentation system 103 does not have access to the computer-implemented model 101 during the development of computer-implemented model 101, but in which the developed computer-implemented model 101 is rather received by the computer-implemented model documentation system 103 from a distinct (e.g., third party) system. In such embodiments, a history of the development of the computer-implemented model 101 may be provided to the computer-implemented model documentation system 103 for use in documenting the computer-implemented model 101. In alternative embodiments, the developed computer-implemented model 101 may be provided to the computer-implemented model documentation system 103 without any development history for use in documenting the computer-implemented model 101.

The computer-implemented model documentation system 103 can also document the computer-implemented model 101 at any one or more phases during and/or following deployment of the computer-implemented model. For example, the computer-implemented model 101 can be documented by the computer-implemented model documentation system 103 continually or intermittently at specific points during deployment. This documentation of the computer-implemented model 101 during deployment can occur in real-time, or can occur retrospectively based on a history of the deployment of the computer-implemented model 101. This deployment-based documentation of the computer-implemented model 101 can serve as an ongoing check or control on the computer-implemented model 101 during use.

In addition to obtaining the computer-implemented model 101, the computer-implemented model documentation system 103 also obtains the documentation template 102. As referred to herein, the term “documentation template” may refer computer-implemented model documentation that is at least partially unpopulated. More specifically, a documentation template may comprise placeholders for content characterizing a computer-implemented model. One or more of the content placeholders of a documentation template are at least partially unpopulated with content. In other words, one or more of the content placeholders of a documentation template represent content that is incomplete. Following selection of a particular computer-implemented model for documentation, the content placeholders of a documentation template can be populated with content characterizing the particular computer-implemented model, thereby generating documentation for the particular computer-implemented model.

Documentation templates are defined at least in part by the content placeholders that they comprise. Specifically, content placeholders can vary widely across documentation templates, and a particular documentation template may be selected for use in documenting a particular computer-implemented model based on the content placeholders of the documentation template. In some embodiments, a documentation template can be selected for documentation of a computer-implemented model by a user via a graphical user interface. In some embodiments, documentation templates can be organized according to guidelines provided by a particular entity, for example, a regulatory body. Content placeholders and the corresponding content that populates these placeholders are discussed in further detail below.

As discussed above, one of the challenges posed by current methods for computer-implemented model documentation is the lack of documentation standardization across computer-implemented models. Specifically, while documentation of computer-implemented models can be required to conform to specific standardized formats, computer-implemented model documentation can vary widely according to the responsible documenter. Not only is this non-standardized method of model documentation inefficient in itself, but not-standardized model documentation can further result in inefficient review and evaluation of completed documentation by auditors.

Documentation templates provide a much-needed solution to this problem by providing standardized and reusable templates for computer-implemented model documentation. Specifically, as discussed in further detail below with regard to FIG. 2, documentation templates can be stored in a documentation template store, and reused indefinitely to generate documentation for any quantity of computer-implemented models. This use of existing, standardized documentation templates both increases the efficiency of generating model documentation, and also seamlessly standardizes the model documentation process.

In addition to selecting existing documentation templates from a documentation template store, in a some embodiments, users can also customize documentation templates for documentation of particular computer-implemented models. Specifically, users can create new documentation templates and/or edit existing documentation templates to include particular content placeholders. These new and/or edited documentation templates can also be saved in the documentation template store for future use.

Following obtention of the computer-implemented model 101 and the documentation template 102 by the computer-implemented model documentation system 103, the computer-implemented model documentation system 103 automatically generates the computer-implemented model documentation 104. Specifically, the computer-implemented model documentation system 103 automatically generates content for each of the content placeholders of the documentation template 102 based on the computer-implemented model 101. As discussed in further detail below with regard to synthetic content, automatic generation of content for the content placeholders of the documentation template 102 can also optionally be based on a dataset for the computer-implemented model. The dataset can be related to, for example, a training dataset, a validation dataset, and/or a test dataset used to respectively train, validate, and/or test the computer-implemented model 101. The dataset can also be related to, for example, a standardized dataset. For instance, regulators may require documentation of performance of the computer-implemented model 101 on a standardized validation dataset.

The method by which content for the content placeholders of the documentation template 102 is generated by the computer-implemented documentation system 103 depends upon the type of the content placeholders. As discussed in further detail below with regard to Section II.A.2., in general there are two types of content placeholders: static content placeholders and synthetic content placeholders. A documentation template can include static content placeholders and/or synthetic content placeholders.

Static content placeholders are populated with static content. As referred to herein, “static content” with regard to a computer-implemented model may refer to existing content that describes the computer-implemented model. As referred to herein, “existing content” with regard to a computer-implemented model may refer to content that is stored in a computer-readable form prior to initiation of automatic documentation generation for the computer-implemented model. As one example, the computer-readable form may be metadata that is associated with the computer-implemented model. As another example, the computer-readable form may be a database record corresponding to the computer-implemented model. As yet another example, the computer-readable form may be a history of the development and/or deployment of the computer-implemented model, as described above.

Examples of static content for a computer-implemented model may include any existing content describing the computer-implemented model. For example, static content for a computer-implemented model may include a name of the computer-implemented model. As another example, static content for a computer-implemented model may include a number of training samples that were used to train the computer-implemented model. As another example, static content for a computer-implemented model may include an existing positive predictive value of the computer-implemented model.

Static content for a computer-implemented model can also include a graphical representation of any existing content describing the computer-implemented model. For example, static content for a computer-implemented model can include a graphical representation of an existing true positive rate and an existing false positive rate of predictions for the computer-implemented model, in the form of a receiver operating characteristics (ROC) curve.

Because static content exists for a computer-implemented model prior to documentation of the computer-implemented model, automatic determination of static content for static content placeholders of a documentation template comprises the computer-implemented model documentation system 103 identifying the static content that is already recorded for the computer-implemented model. In other words, automatic determination of static content for static content placeholders of a documentation template comprises the computer-implemented model documentation system 103 capturing the static content from the existing computer-readable form for the computer-implemented model.

In contrast to static content placeholders, synthetic content placeholders are populated with synthetic content. As referred to herein, “synthetic content” with regard to a computer-implemented model may refer to non-existing content that that describes the computer-implemented model and that is deduced by automatically performing one or more computations based on the computer-implemented model and one or more datasets. As referred to herein, “non-existing content” with regard to a computer-implemented model may refer to content that is not stored in computer-readable form prior to initiation of automatic documentation generation for the computer-implemented model. Because synthetic content for a computer-implemented model is by definition “non-existing” prior to documentation of the computer-implemented model, the synthetic content for the computer-implemented model is newly generated by performing one or more computations based on the computer-implemented model and one or more datasets. As referred to herein, one or more “computations” with regard to a computer-implemented model may refer to one or more computations performed based on the computer-implemented model and one or more datasets to deduce synthetic content describing the computer implemented model. As discussed briefly above, the dataset on which the computations are based can be, for example, a training dataset, a validation dataset, and/or a test dataset used to respectively train, validate, and/or test the computer-implemented model. The dataset can also be related to, for example, a standardized dataset provided by a regulator. The one or more computations can include, for example, mathematical operations, logic operations, machine-learning operations, statistical analyses, and/or any other types of computations involving the computer-implemented model and the one or more datasets.

As discussed above, in some embodiments, computer-implemented model documentation can be generated based on a history of the development and/or deployment of the computer-implemented model, rather than the computer-implemented model itself. Specifically, in cases in which the computer-implemented model is a model from a third-party system, has already completed development, and/or has already completed deployment, computer-implemented model documentation can be generated based on a history of the development and/or deployment of the computer-implemented model. For instance, as mentioned above, static content for a computer-implemented model can be identified from a computer-readable form including a history of the development and/or deployment of the computer-implemented model. Similarly, synthetic content can also be generated for a computer-implemented model based on a history of the development and/or deployment of the computer-implemented model. Specifically, synthetic content for a computer-implemented model can be generated by performing one or more computations based on existing content included in the history of the development and/or deployment of the computer-implemented model. In other words, non-existing synthetic content can be newly generated for a computer-implemented model by performing one or more computations based on existing content included in a history of the development and/or deployment of the computer-implemented model.

Examples of synthetic content for a computer-implemented model may include any non-existing content describing the computer-implemented model that is deduced by performing one or more computations based on the computer-implemented model and one or more datasets. For example, synthetic content for a computer-implemented model may include a positive predictive value for the computer-implemented model that was non-existing prior to deduction by one or more computations.

Synthetic content for a computer-implemented model can also include a graphical representation of any non-existing content describing the computer-implemented model that is deduced by performing one or more computations based on the computer-implemented model and one or more datasets. For example, in an embodiment in which a positive rate and a false positive rate of predictions for a computer-implemented model were non-existing prior to deduction by one or more computations, synthetic content can be, for example, a graphical representation of the newly generated true positive rate and false positive rate of predictions for the computer-implemented model, in the form of a ROC curve.

Because static content and synthetic content differ from one another based primarily on when, and thus how, they are obtained for inclusion in computer-implemented model documentation, there can be overlap between specific occurrences of static and synthetic content. For example, as discussed above, a positive predictive value of a computer-implemented model can occur in the computer-implemented model documentation as static content or as synthetic content, depending upon the manner in which the positive predictive value was obtained. Specifically, if the positive predictive value was existing content stored in a computer-readable form prior to initiation of automatic documentation generation for the computer-implemented model, and was thus simply captured from the existing computer-readable form for inclusion in the computer-implemented model documentation, then the positive predictive value is considered static content. On the other hand, if the positive predictive value was non-existing content that was not stored in a computer-readable form prior to initiation of automatic documentation generation for the computer-implemented model, and thus was deduced by performing one or more computations based on the computer-implemented model and one or more datasets for inclusion in the computer-implemented model documentation, then the positive predictive value is considered synthetic content. Therefore, in summary, depending upon how content is obtained for inclusion in computer-implemented model documentation, there can be overlap in the specific occurrences of static and synthetic content. Additional examples of static and synthetic content are provided below in Section II.A.2.

Following generation of the content for the content placeholders of the documentation template 102, the computer-implemented model documentation system 103 automatically populates the content placeholders of the documentation template 102 with the respective generated content. In some embodiments, automatic population of content placeholders of the documentation template 102 can be achieved using metadata tags. Specifically, content placeholders of the documentation template 102 can include metadata tags that reference content generated by the computer-implemented model documentation system 103. In this way, content placeholders of the documentation template 102 can be automatically populated with content to create the documentation 104. The population of the content placeholders of the documentation template 102 effectively generates the documentation 104 for the computer-implemented model 101.

As discussed above, one principal challenge posed by current methods of manual documentation of computer-implemented models is the amount of time and the expense of the resources necessary to complete the documentation. Specifically, as mentioned above, manual documentation of a computer-implemented model is typically performed by a developer of the computer-implemented model, whose time can be an expensive resource. Additionally, manual generation of documentation for a single computer-implemented model generally requires approximately 3-6 months to complete. Automated documentation of computer-implemented models by some embodiments of the computer-implemented model documentation system 103 can alleviate this expense and inefficiency by reducing the time and resources required for documentation.

FIG. 2 is a block diagram of an architecture of a computer-implemented model documentation system 200 configured to automatically generate documentation for computer-implemented models, in accordance with an embodiment. As shown in FIG. 2, the computer-implemented model documentation system 200 includes a computer-implemented model store 201, a documentation template store 202, a graphical user interface 203, and a documentation generation module 204. In some embodiments, the computer-implemented model documentation system 200 may include additional, fewer, or different components for various applications. Similarly, the functions can be distributed among the modules in a different manner than is described here. In FIG. 2, conventional components related to network interfaces, security functions, load balancers, failover servers, management and network operations consoles, and the like are not shown so as to not obscure the details of the system architecture.

Turning to the components of the computer-implemented model documentation system 200, the computer-implemented model store 201 stores one or more computer-implemented models to be documented by the computer-implemented model documentation system 200. As discussed above, a computer-implemented model may be any model that is at least in part implemented by a computer system. As an example, a computer-implemented model can be a machine-learned predictive model learned by a computer system based on a training dataset.

Computer-implemented models can be added to or removed from the computer-implemented model store 201. In some embodiments, computer-implemented models included in the computer-implemented model store 201 can be obtained from other components of the computer-implemented model documentation system 200, not depicted in FIG. 2. In alternative embodiments, computer-implemented models included in the computer-implemented model store 201 can be received by the computer-implemented model documentation system 200 from a source external to the computer-implemented model documentation system 200. Specifically, computer-implemented models included in the computer-implemented model store 201 can be received from a remote (e.g., third-party) system.

The documentation template store 202 stores one or more documentation templates for use in generating documentation for computer-implemented models from the computer-implemented model store 201. As discussed above, a documentation template includes computer-implemented model documentation that is at least partially unpopulated. More specifically, a documentation template may include placeholders for content characterizing a computer-implemented model. One or more of the content placeholders of a documentation template are at least partially unpopulated with content. As discussed below, documentation templates can be added to or removed from the documentation template store 202.

The graphical user interface 203 is an input/output interface that is configured to receive user input to the computer-implemented documentation system 200, and to provide output to a user from the computer-implemented documentation system 200. For instance, a user can add a computer-implemented model to the computer-implemented model store 201 and/or remove a computer-implemented model from the computer-implemented model store 201 via input to the graphical user interface 203. A user can also select a computer-implemented model from the computer-implemented model store 201 for documentation by the computer-implemented model documentation system.

A user can interact with the documentation template store 202 via the graphical user interface 203. For instance, a user can add a documentation template to the documentation template store 202 and/or remove a documentation template from the documentation template store 202 via input to the graphical user interface 203. A user can also select a documentation template from the documentation template store 202 for use in documenting a computer-implemented model. Even further, a user can create a new documentation template or edit an existing documentation template using the graphical user interface 203. Specifically, a user can create a new documentation template for addition to the documentation template store 202 via input to the graphical user interface 203. A user can also edit an existing documentation template from the documentation template store 202, and then add the edited documentation template back to the documentation template store 202.

Creating and editing documentation templates can include updating the format, layout, file type, and/or contents of the documentation templates. For instance, in some embodiments, creating and editing documentation templates can include adding and/or removing one or more static and/or synthetic content placeholders from the documentation templates.

When documentation for a computer-implemented model has been generated by the computer-implemented model documentation system 200, the graphical user interface 203 can present the completed documentation to the user. The user can then review and if necessary, further edit the documentation via the graphical user interface 203.

The documentation generation module 204 is configured to automatically generate documentation for a computer-implemented model from the computer-implemented model store 201 using a documentation template from the documentation template store 202. More specifically, the documentation generation module 204 is configured to automatically generate content for each of the content placeholders of the documentation template based on the computer-implemented model, and then automatically populate the content placeholders of the documentation template with the respective generated content. This population of the content placeholders of the documentation template effectively generates the documentation for the computer-implemented model.

In the case of static content placeholders, the documentation generation module 204 automatically identifies and retrieves static content for the computer-implemented model from an existing computer-readable form and then automatically populates the static content placeholders of the documentation template with this static content. In the case of synthetic content placeholders, the documentation generation module 204 automatically generates synthetic content by automatically performing one or more computations based on the computer-implemented model and one or more datasets. As discussed above, the dataset on which the computations are based can be, for example, a training dataset, a validation dataset, and/or a test dataset used to respectively train, validate, and/or test the computer-implemented model. The dataset can also be related to, for example, a standardized dataset provided by a regulator. The one or more computations can include, for example, mathematical operations, logic operations, machine-learning operations, statistical analyses, and/or any other types of computations involving the computer-implemented model and the one or more datasets. Following generation of the synthetic content, the documentation generation module 204 automatically populates the synthetic content placeholders of the documentation template with this synthetic content. The documentation generation module 204 returns completed documentation for a computer-implemented model to the graphical user interface 203 for presentation to a user.

FIG. 3 is a block diagram of a system environment 300 in which a computer-implemented model documentation system 301 operates, in accordance with an embodiment. The system environment 300 shown in FIG. 3 includes the computer-implemented model documentation system 301, a network 302, and a remote (e.g., third-party) system 303. In alternative configurations, different and/or additional components may be included in the system environment 300.

The computer-implemented model documentation system 301 and the remote system 303 are coupled to the network 302 such that the computer-implemented model documentation system 301 and the remote system 303 are in communication with one another via the network 302. The computer-implemented model documentation system 301 and/or the remote system 303 can each comprise a computing system capable of transmitting and/or receiving data via the network 302. For example, the remote system 303 can transmit computer-implemented models, documentation templates, and/or instructions for creating and/or editing a documentation template to the computer-implemented model documentation system 301. Similarly, the computer-implemented model documentation system 301 can transmit completed computer-implemented model documentation to the remote system 303. Transmission of data over the network 302 can include transmission of data via the interne, wireless transmission of data, non-wireless transmission of data (e.g., transmission of data via ethernet), or any other form of data transmission. In one embodiment, the computer-implemented model documentation system 301 and/or the remote system 303 can each include (1) one or more conventional computer systems, e.g., desktop computers, laptop computers, or servers, and/or (2) one or more virtualized machines or containers, e.g., cloud-enabled virtual machines or docker images, running on one or more conventional computer systems.

Alternatively, the computer-implemented model documentation system 301 and/or the remote system 303 each can be or include a device having computer functionality, e.g., a personal digital assistant (PDA), a mobile telephone, a smartphone, or another suitable device. In further embodiments, the computer-implemented model documentation system 301 and/or the remote system 303 can be or include a non-transitory computer-readable storage medium storing computer program instructions that when executed by a computer processor, cause the computer processor to operate in accordance with the methods discussed throughout this disclosure. In even further embodiments, the computer-implemented model documentation system 301 and/or the remote system 303 can be or include cloud-hosted computing systems (e.g., computing systems hosted by Amazon Web Services™ (AWS)).

In some embodiments, the remote system 303 can execute an application allowing the remote system 303 to interact with the computer-implemented model documentation system 301. For example, the remote system 303 can execute a browser application to enable interaction between the remote system 303 and the computer-implemented model documentation system 301 via the network 302. In another embodiment, the remote system 303 can interact with the computer-implemented model documentation system 301 through an application programming interface (API) running on native operating systems of the remote system 303, e.g., IOS® or ANDROID™. In one embodiment, the remote system 303 can communicate data to the computer-implemented model documentation system 301.

The network 302 can comprise any combination of local area and/or wide area networks, using both wired and/or wireless communication systems. In one embodiment, the network 302 uses standard communications technologies and/or protocols. For example, the network 302 can include communication links using any suitable network technologies, e.g., Ethernet, 802.11, worldwide interoperability for microwave access (WiMAX), 3G, 4G, 5G, code division multiple access (CDMA), digital subscriber line (DSL), etc. Examples of networking protocols used for communicating via the network 302 include multiprotocol label switching (MPLS), transmission control protocol/Internet protocol (TCP/IP), hypertext transport protocol (HTTP), simple mail transfer protocol (SMTP), file transfer protocol (FTP), and voice over internet protocol (VoIP). Data exchanged over the network 302 may be represented using any suitable format, e.g., hypertext markup language (HTML), extensible markup language (XML), or audio. In some embodiments, all or some of the communication links of the network 302 may be encrypted using any suitable technique or techniques.

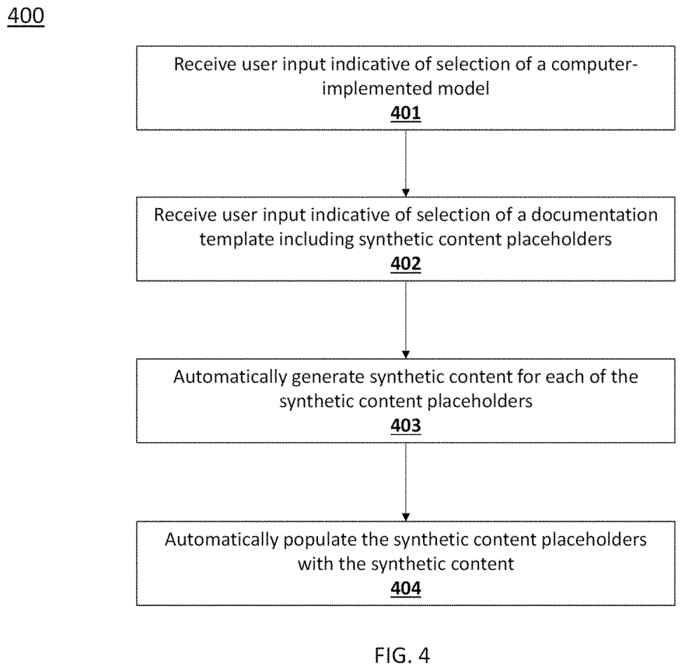

FIG. 4 is a flow chart of a method 400 for automated generation of computer-implemented model documentation, in accordance with an embodiment. In some embodiments, the method may include different and/or additional steps than those shown in FIG. 4. Additionally, steps of the method may be performed in different orders than the order described in conjunction with FIG. 4.

As shown in FIG. 4, a computer-implemented model documentation system receives 401 user input indicative of selection of a computer-implemented model. As discussed above, this input received from the user can be received via a graphical user interface of the computer-implemented model documentation system. In some embodiments, the user input can indicate the computer-implemented model itself, as stored by the computer-implemented model documentation system and/or as provided by the user (e.g., via a third party system) to the computer-implemented model documentation system. In some additional or alternative embodiments, the user input can indicate a history of the development and/or deployment of the computer-implemented model.

The computer-implemented model documentation system receives 402 user input indicative of selection of a documentation template including one or more synthetic content placeholders. As with the computer-implemented model, this input received from the user can be received via a graphical user interface of the computer-implemented model documentation system. In some embodiments, the user input can indicate a documentation template stored by the computer-implemented model documentation system and/or provided by the user (e.g., via a third party system) to the computer-implemented model documentation system. As discussed above, the user can also edit existing documentation templates or create new documentation templates via a graphical user interface of the computer-implemented model documentation system.

In general, a documentation template includes one or more static and/or synthetic content placeholders. In a particular embodiment, the documentation template selected by the user in step 402 includes at least one synthetic content placeholder. In this particular embodiment, the documentation template may also include one or more static content placeholders. In some embodiments in which the user edits and/or creates the documentation template received by the computer-implemented model documentation system in step 402, the user can customize the documentation template by removing and/or adding one or more content placeholders to the documentation template.

The computer-implemented model documentation system automatically generates 403 synthetic content for each of the synthetic content placeholders in the selected template. As discussed above, automatic generation of synthetic content may include performing one or more computations based on the computer-implemented model received in step 401 and one or more datasets. In embodiments in which the computer-implemented model documentation system receives a history of the development and/or deployment of the computer-implemented model in step 401, the history of the development and/or deployment of the computer-implemented model can also or can alternatively be used in the generation 403 of the synthetic content. Specifically, the computer-implemented model documentation system can perform the one or more computations based on the existing content in the history of the development and/or deployment of the computer-implemented model to generate the synthetic content that was non-existing prior to the initiation of documentation.

In embodiments in which the documentation template received in step 402 also includes static content placeholder(s), the computer-implemented model documentation system can also automatically generate static content for each of the static content placeholders. As discussed above, automatic generation of static content includes identifying and retrieving existing content from a computer-readable form for the computer-implemented model. In embodiments in which the computer-implemented model documentation system receives a history of the development and/or deployment of the computer-implemented model in step 401, the history of the development and/or the deployment of the computer-implemented model can also or can alternatively be used in the generation of the static content. Specifically, the computer-implemented model documentation system can identify and retrieve static content from content in the history of the development and/or deployment of the computer-implemented model that was existing prior to the initiation of documentation.

Then, the computer-implemented model documentation system automatically populates 404 the synthetic content placeholders of the documentation template selected in step 402 with the synthetic content generated in step 403. In embodiments in which the documentation template also includes static content placeholders, the computer-implemented model documentation system can also automatically populate the static content placeholders of the documentation template with the generated static content. In this way, documentation for the computer-implemented model can be automatically generated by the computer-implemented model documentation system.

II.A. Model Documentation Template Structure and Contents

II.A.1. Documentation Template Sections

In general, a computer-implemented model documentation template may be organized into one or more sections. As referred to herein a “section” with regard to a documentation template may refer to a group of content placeholders, which may be denoted by a section title. As an example, a section of a documentation template may be denoted by a section title of “Overview of Model Results.” Furthermore, the “Overview of Model Results” section of the documentation template can include a group of static and/or synthetic content placeholders, for example, a synthetic content placeholder for a ROC Curve.

As discussed in detail below in Section II.B., via a graphical user interface of the computer-implemented model documentation system, a user can add and/or delete sections of a documentation template, rename sections of a documentation template, and re-order sections of a documentation template. In other words, a user of the computer-implemented model documentation system can include any chosen section in a documentation template, denoted by any chosen section title. The following list includes exemplar section titles for a documentation template, in accordance with an embodiment. However, note that the section titles included in this list are examples only—a documentation template can include any alternative section titles.
Model Description and Overview
Overview of Model Results
Model Development Overview
Model Assumptions
Model Methodology
Literature Review and References
Alternative Model Frameworks and Theories Considered
Variable Selection
Model Validation Stability
Model Performance (out-of-sample) (key performance metrics across training and inferencing pipelines)
Sensitivity Testing and Analysis

As discussed in further detail below in Section II.A.2., sections of a documentation template can include any static and/or synthetic content placeholder(s). Content placeholders can be located within sections of the documentation template based on the section titles. Specifically, content placeholders located within a particular section of a documentation template can be populated with content that describes a facet of a computer-implemented model indicated by the title of the section. For example, the section titled “Model Description and Overview” can include content placeholder(s) to be populated with content describing a problem to be solved by a computer-implemented model. As another example, the section titled “Model Description and Overview” can include content placeholder(s) to be populated with content indicating a prediction that is to be made by the computer-implemented model.

As another example, the section titled “Overview of Model Results” can include content placeholder(s) to be populated with content describing results obtained at one or more steps (e.g., each step) during development of a computer-implemented model.

As another example, the section titled “Model Development Overview” can include content placeholder(s) to be populated with, for example, a graphical representation of a development blueprint for a computer-implemented model, the blueprint depicting tasks throughout the process of developing the computer-implemented model, from data ingestion to result prediction. The section titled “Model Development Overview” can include content placeholder(s) to be populated with content describing management of updated versions a computer-implemented model, e.g., content describing model builders, model update dates, and/or model version approvals. The “Model Development Overview” section can include content placeholder(s) to be populated with content describing how a hyperparameter space for a computer-implemented model was searched and how the computer-implemented model was tuned according to identified hyperparameters.

As another example, the section titled “Model Methodology” can include content placeholder(s) to be populated with content describing one or more steps (e.g., each step) performed by a computer-implemented model, including, for example, data processing steps, feature engineering steps, and determination of model parameters.

As another example, the section titled “Literature Review and References” can include content placeholder(s) to be populated with any suitable content, e.g., references to academic literature supporting development of a computer-implemented model.

As another example, the section titled “Alternative Model Frameworks and Theories Considered” can include content placeholder(s) to be populated with content describing alternative approaches to development of a computer-implemented model that were evaluated but not ultimately selected for use in development of the computer-implemented model.

As another example, the section titled “Variable Selection” can include content placeholder(s) to be populated with content describing one or more (e.g., all) variables (e.g., features) included in data samples processed by a computer-implemented model, content describing how an initial set of variables included in data samples processed by a computer-implemented model were reduced to create a final set of variables included in data samples processed by the computer-implemented model, and/or content describing any weighting and/or down-sampling applied to data samples processed by a computer-implemented model.

As another example, the section titled “Model Performance” can include content placeholder(s) to be populated with content describing performance metrics for a computer-implemented model during development and/or deployment. The “Model Performance” section can include content placeholder(s) to be populated with content describing how held-out sample validation was performed for a computer-implemented model and/or for one or more benchmark models. For instance, the section can include content placeholder(s) to be populated with content describing how data samples were selected for the held-out sample validation of the computer-implemented model and/or the one or more benchmark models. The “Model Performance” can include content placeholder(s) to be populated with any suitable content describing deployment of a computer-implemented model, e.g., a deployment URL and a deployment server.

However, note that these examples of content included in the above exemplar documentation template sections are examples only—the sections of a documentation template can include any alternative content.

II.A.2. Content Placeholders

Each section of a model documentation template can include one or more static and/or synthetic content placeholders. And as discussed in detail below in Section II.B., a user can add static and/or synthetic content placeholders to sections of a documentation template via a graphical user interface of the computer-implemented model documentation system. In some embodiments, a user can select content placeholders provided by the computer-implemented model documentation system for inclusion in sections of a model documentation template. Examples of these content placeholders provided by the computer-implemented model documentation system are depicted in screen shots of the graphical user interface of the computer-implemented model documentation system in FIG. 21. In alternative embodiments, a user can create custom content placeholders for inclusion in sections of a model documentation template. During documentation of a computer-implemented model, the content placeholders of the documentation template are automatically populated with content to generate the computer-implemented model documentation.

As discussed above, in general there are two types of content placeholders: static content placeholders and synthetic content placeholders. Static content placeholders are automatically populated with static content. Synthetic content placeholders are automatically populated with synthetic content. The sections of a documentation template can include static content placeholders and/or synthetic content placeholders. Examples of static content and synthetic content are discussed in detail below.

Despite the segregation of examples of static content and synthetic content provided below, as discussed above, there can be overlap in the specific occurrences of static and synthetic content. Specifically, static content and synthetic content differ from one another based on when, and thus how, they are obtained for inclusion in computer-implemented model documentation. Static content is existing content that is stored in a computer-readable form prior to initiation of documentation generation. To populate a documentation template with static content, the static content is simply captured from the computer-readable form. On the other hand, synthetic content is non-existing content that is not stored in a computer-readable form prior to initiation of documentation generation. Thus to populate a documentation template with synthetic content, the synthetic content is generated by performing one or more computations based on the computer-implemented model and one or more datasets. As a result, depending upon how content is obtained for inclusion in computer-implemented model documentation, some content can be classified as static content or synthetic content.

### Static Content

As referred to herein, “static content” with regard to a computer-implemented model may refer to existing content that describes the computer-implemented model. As referred to herein “existing content” with regard to a computer-implemented model may refer to content that is stored in computer-readable form prior to initiation of automatic documentation generation for the computer-implemented model. Because static content exists in computer-readable form prior to documentation of a computer-implemented model, automatic determination of static content comprises identification of the static content that is already recorded for the computer-implemented model. In other words, automatic determination of static content comprises capturing the static content from the existing computer-readable form for the computer-implemented model.

One example of static content is recorded text that describes a computer-implemented model. For example, static content can include a name of the computer-implemented model, e.g., “Gradient Boosted Trees Classifier with Early Stopping.” As another example, static content can include an indication of software that was used to develop a computer-implemented model, e.g., “v0005e6d of DataRobot.” As another example, static content can include a date and/or a time at which construction of a computer-implemented model was initiated, e.g., “2019-06-24 15:57:50.”

Other examples of static content include any recorded parameters used in the modeling process by a computer-implemented model, and/or a set of logged decisions that were made by a user during development of a computer-implemented model.

Another example of static content is citations to literature references used in development of a computer-implemented model. These literature references can be recorded for the computer-implemented model and/or can be known references associated with a type of the computer-implemented model.

The above examples of static content are examples only, and are not exhaustive. Any suitable data that exists in computer-readable form for a computer-implemented model prior to initiation of automatic documentation generation for the computer-implemented model can be used as static content.

### Synthetic Content

As referred to herein, “synthetic content” with regard to a computer-implemented model may refer to content describing the computer-implemented model that is not stored in computer-readable form prior to initiation of documentation for the computer-implemented model. Synthetic content is automatically generated during the computer-implemented model documentation process by automatically performing one or more computations based on the computer-implemented model and one or more datasets.

Automatic generation of synthetic content for documentation of a computer-implemented model can depend upon the origin of the computer-implemented model and/or on the stage of development or deployment of the computer-implemented model when the synthetic content is generated. For example, a computer-implemented model can undergo documentation of development and/or deployment of the computer-implemented model during development and/or deployment of the computer-implemented model, respectively. In such a case, synthetic content describing the computer-implemented model can be generated by performing computations based on the computer-implemented model itself and one or more datasets. For instance, in such a case, synthetic content describing the computer-implemented model can be generated by performing computations based on one or more inputs and/or outputs of the computer-implemented model operating on one or more datasets. As another example, a computer-implemented model can undergo documentation of development and/or deployment following completion of development and/or deployment of the computer-implemented model, respectively. In such a case, synthetic content describing the computer-implemented model can be generated by performing computations based on content of a history of development and/or deployment of the computer-implemented model, respectively. As another example, a computer-implemented model from a third-party system can undergo documentation without providing direct access to the computer-implemented model. In such cases, a history of the development and/or deployment of the third-party computer-implemented model can be provided by the third-party system, without actually providing access to the computer-implemented model itself, for utilization in generation of synthetic content for the computer-implemented model.

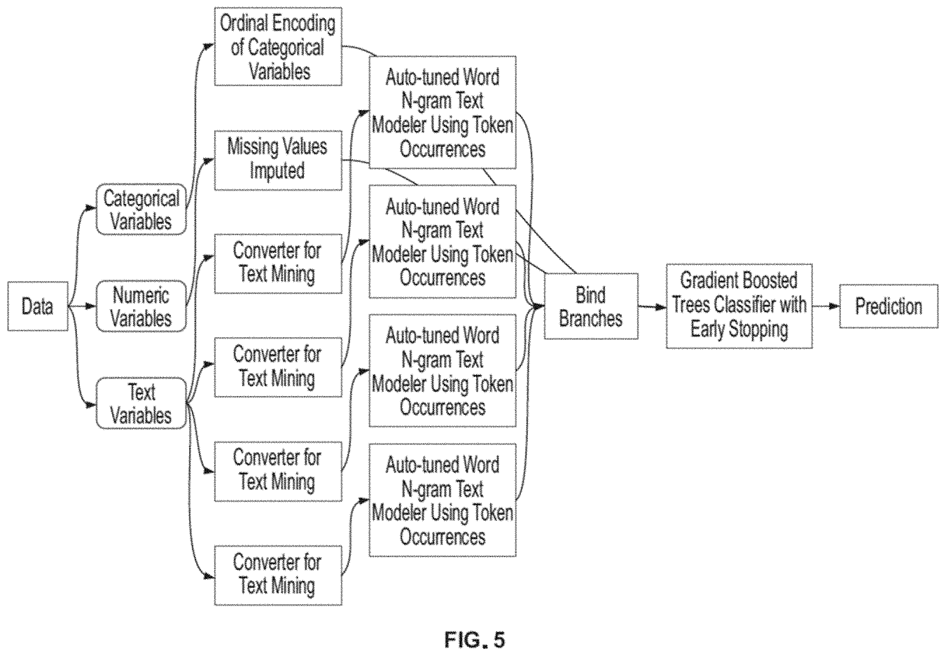

One example of synthetic content is a development blueprint for a computer-implemented model. A development blueprint for a computer-implemented model may include a plurality of tasks (e.g., steps) performed to develop the computer-implemented model. These tasks can include any suitable data processing steps and/or algorithms. A development blueprint for a computer-implemented model can be provided in any format within documentation of the computer-implemented model. For example, a development blueprint for a computer-implemented model can be provided in a graphical representation and/or in a list. FIG. 5 is an exemplar graphical representation of a development blueprint for a computer-implemented model, in accordance with an embodiment. The nodes of the development blueprint depicted in FIG. 5 can include one or more tasks. In some embodiments, synthetic content can also include textual descriptions of the functions of the one or more tasks of the development blueprint.

Another example of synthetic content is a description of validation data samples and/or cross-validation data samples used to validate a computer-implemented model. For example, the synthetic content may include a number of validation data samples and/or cross-validation data samples used to validate a computer-implemented model. As another example, the synthetic content may include an indication of whether the validation data samples and/or cross-validation data samples used to validate a computer-implemented model were held-out from training of the computer-implemented model. As another example, the synthetic content may include a percentage of data samples held-out from training of the computer-implemented model for validation and/or cross-validation of the computer-implemented model. As another example, the synthetic content may include a description of a partition of data samples for k-fold cross-validation.

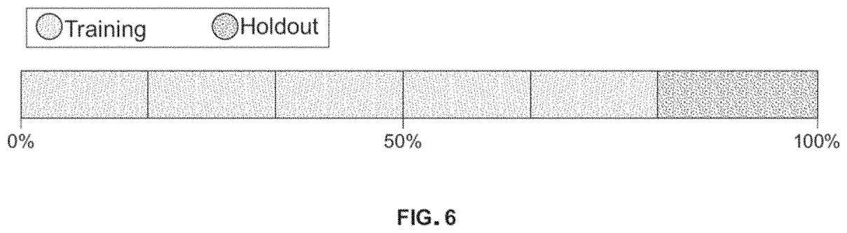

FIG. 6 is an exemplar graphical representation of a percentage of data samples held-out from training of a computer-implemented model for validation of the computer-implemented model, in accordance with an embodiment. In the example of FIG. 6, the percentage of data samples held-out from training for validation is 20%. Conversely, the percentage of data samples used for training, and furthermore for cross-validation, is 80%. In the example of FIG. 6, the training data samples used for training and cross-validation are further partitioned into five distinct sets of data samples for use in 5-fold cross-validation.

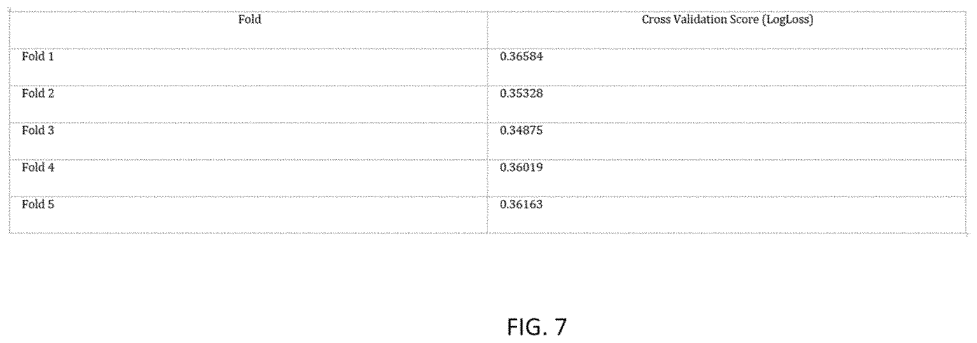

Another example of synthetic content is validation and/or cross-validation performance scores generated for a computer-implemented model. FIG. 7 is a graphical representation of a table depicting exemplar performance scores for each fold of a 5-fold cross-validation performed for a computer-implemented model, in accordance with an embodiment. In the example of FIG. 7, the performance scores were generated according to a Log-Loss performance metric.

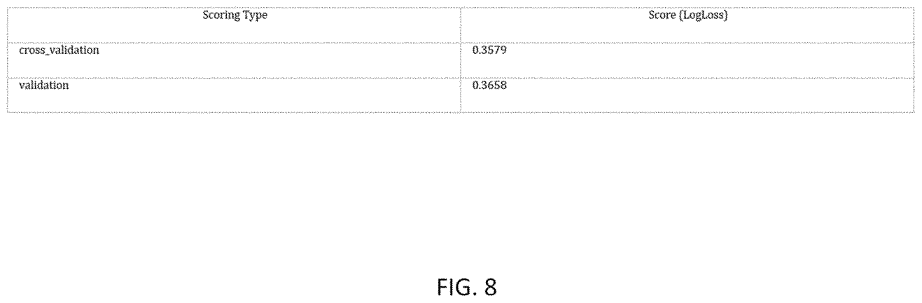

Similarly, FIG. 8 is a graphical representation of a table depicting exemplar validation and cross-validation performance scores generated for a computer-implemented model, in accordance with an embodiment. In the example of FIG. 8, the validation performance score was generated for the computer-implemented model based on held-out data samples and according to a Log-Loss performance metric. The cross-validation performance score as depicted in FIG. 8 may be a mean of the cross-validation performance scores for each of the folds as depicted in FIG. 7.

Another example of synthetic content is a confusion matrix for a computer-implemented model. A confusion matrix is a depiction (often a tabular depiction) of values that characterize the performance of a model. In some embodiments, a confusion matrix depicts a quantity (or rate) of true positive predictions generated by a computer-implemented model, a quantity (or rate) of false positive predictions generated by the computer-implemented model, a quantity (or rate) of false negative predictions generated by the computer-implemented model, and a quantity (or rate) of true negative predictions generated by the computer-implemented model. The data indicated in a confusion matrix can also be provided in any other suitable format, e.g., a list.

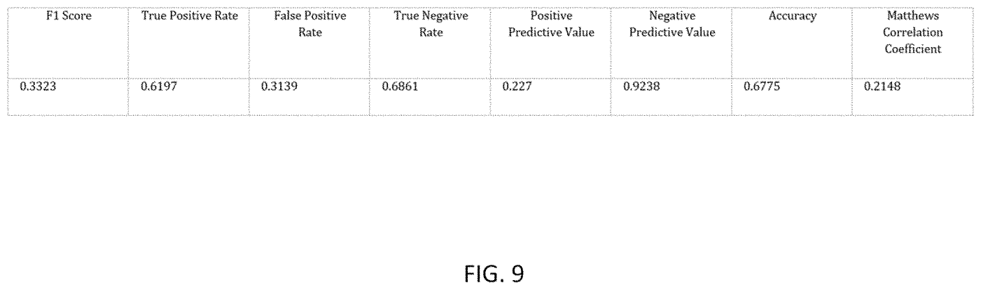

FIG. 9 is a graphical representation of a table that depicts exemplar values used to generate a confusion matrix for a computer-implemented model, in accordance with an embodiment. The table in FIG. 9 includes values for an Fl score, a true positive rate, a false positive rate, a true negative rate, a positive predictive value, a negative predictive value, an accuracy, and a correlation coefficient (e.g., Matthews correlation coefficient) for a computer-implemented model. The Fl score is a measure of an accuracy of the computer-implemented model, based on precision and recall of the computer-implemented model. The true positive rate is recall or sensitivity of the computer-implemented model. More specifically, the true positive rate is a ratio of a number of true positive predictions to a total number of actual positives. The false positive rate is fallout of the computer-implemented model. More specifically, the false positive rate is a ratio of a number of false positive predictions to a total number of actual negatives. The true negative rate is specificity of the computer-implemented model. More specifically, the true negative rate is a ratio of a number of true negative predictions to a total number of actual negatives. The positive predictive value is a precision of the computer-implemented model. More specifically, the positive predictive value is a percentage of the actual positives that were correctly predicted by the computer-implemented model. Conversely, the negative predictive value is a percentage of the actual negatives that were correctly predicted by the computer-implemented model. The accuracy of the computer-implemented model is a percentage of correct (positive or negative) predictions made by the computer-implemented model. The Matthews correlation coefficient of the computer-implemented model is a measure of a performance of the computer-implemented model when target feature class sizes are unbalanced. The Matthews correlation coefficient is based on the true positive rate, the true negative rate, the false positive rate, and the false negative rate of the computer-implemented model.

Another example of synthetic content is the value of an accuracy metric for a computer-implemented model. The accuracy metric may be an area-under-the-curve (AUC) metric, a Log-Loss metric, a root-mean-squared-error (RMSE) metric, or any other measure of accuracy.

Another example of synthetic content is an accuracy of a computer-implemented model over time. Another example of synthetic content is an indication of series accuracy of a computer-implemented model. Another example of synthetic content is an indication of stability of a computer-implemented model. Another example of synthetic content is an indication of forecast accuracy of a computer-implemented model. These above examples of time-dependent synthetic content are particularly informative for documentation of computer-implemented time-series models.

Another example of synthetic content is a lift chart. A lift chart is a graphical representation of the accuracy of a computer-implemented model. A lift chart may indicate how well a model separates high values of a target from low values of a target. In some examples, a lift chart may be generated by (1) segmenting the permissible target values for a set of data samples into distinct values or sets (e.g., ranges) of values, referred to herein as “bins,” (2) assigning data samples to the corresponding bins based on their target values, (3) determining, for each bin, (i) the average of the target values predicted by the model for the bin's data samples and (ii) the average of the actual target values for the bin's data samples, and (4) plotting the average predicted target values and average actual target values against the bins (e.g., with the bins arranged on the x-axis in ascending order of average predicted target value, and with the average target values represented by the y-axis). With such a lift chart, the accuracy of the model generally increases as the positive slope of the curve representing the average actual target values increases, and as the curve representing the average predicted target values more closely matches the curve representing the average actual target values.

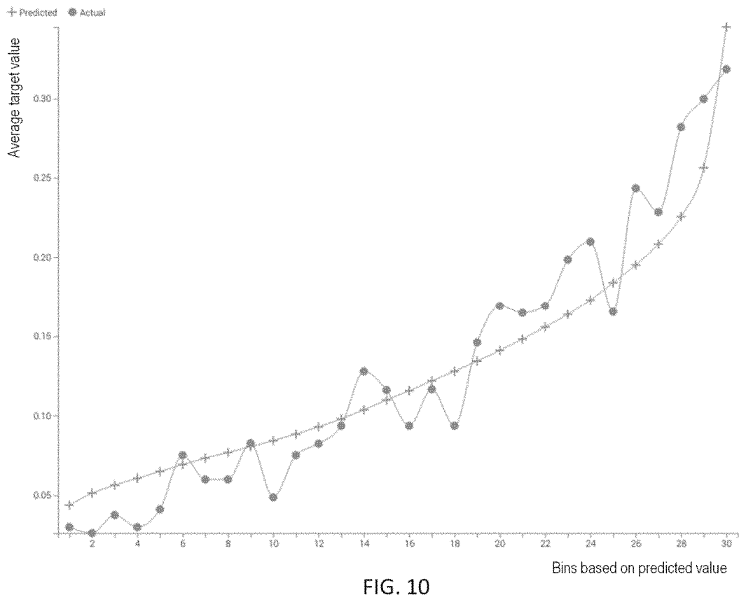

FIG. 10 is an exemplar lift chart for a computer-implemented model, in accordance with an embodiment. The line labeled as “Predicted” in the lift chart indicates average values predicted by a computer-implemented model for a target variable based on the data samples in each bin. The line labeled as “Actual” in the lift chart indicates average actual values of the target variable for the data samples in each bin.

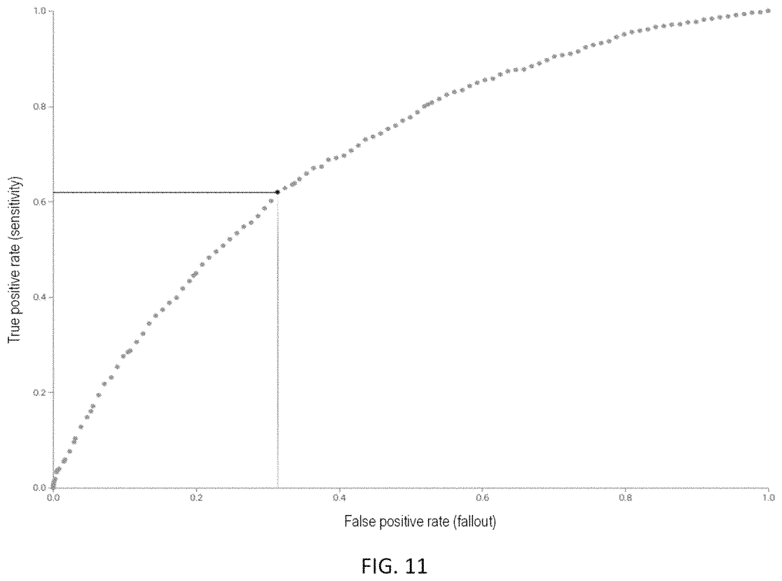

Another example of synthetic content is a receiver operating characteristics (“ROC”) curve. A ROC curve is a graphical representation of a predictive ability of a computer-implemented model as its discrimination threshold is varied. A ROC curve is generated by plotting a true positive rate of predictions generated by a computer-implemented model against a false positive rate of predictions generated by the computer-implemented model, at various discrimination thresholds. FIG. 11 is an exemplar ROC curve for a computer-implemented model, in accordance with an embodiment.

Another example of synthetic content is a prediction distribution graph for a computer-implemented model. A prediction distribution graph depicts a distribution of probabilities generated by a computer-implemented model for data samples, in relation to a threshold. The prediction distribution graph includes histograms illustrating distributions of probabilities for data samples having each actual class value of a target feature. Specifically, each histogram illustrates a distribution of probabilities for data samples having a particular actual class value of a target feature. The threshold of the prediction distribution graph illustrates the threshold according to which the computer-implemented model predicts class values of the target feature for data samples. For example, every data sample to the left of the threshold in the prediction distribution graph is classified by the computer-implemented model as having a first class value A of a target feature and every data sample to the right of the threshold in the prediction distribution graph is classified by the computer-implemented model as having a second class value B of the target feature. Therefore, a prediction distribution graph illustrates how well a computer-implemented model predicts class values of a target feature for data samples.

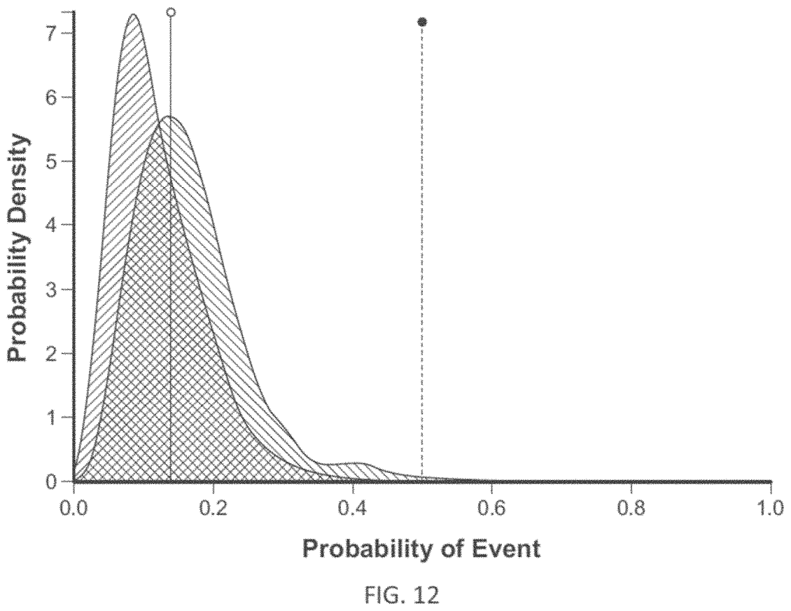

FIG. 12 is an exemplar prediction distribution graph for a computer-implemented model, in accordance with an embodiment. The region filled with cross-hatching traveling upwards from left to right is a histogram of probabilities for data samples having an actual class value A of a target feature. The region with cross-hatching traveling downwards from left to right is a histogram of probabilities for data samples having an actual class value B of a target feature. The line indicating an approximately 15% event probability is the current threshold according to which the computer-implemented model predicts class values of the target feature. Every data sample to the left of this current threshold line in the prediction distribution graph is classified by the computer-implemented model as having the class value A of the target feature and every data sample to the right of this current threshold line in the prediction distribution graph is classified by the computer-implemented model as having the class value B of the target feature. The region of classification uncertainty is where the histograms overlap. Thus more accurate computer-implemented models demonstrate less overlap between the histograms of the prediction distribution graph.

Another example of synthetic content is an indication of feature impact. As referred to herein, a “feature” of a data sample can be a measurable property of an entity (e.g., person, thing, event, activity, etc.) represented by or associated with the data sample. For example, a feature can be the age of a person. In some cases, a feature of a data sample is a description of (or other information regarding) an entity represented by or associated with the data sample.

A value of a feature may be a measurement of the corresponding property of an entity or an instance of information regarding an entity. For instance, in the above example in which a feature is the age of a person, a value of the feature can be 30 years. As referred to herein, a value of a feature can also refer to a missing value (e.g., no value). For instance, in the above example in which a feature is the age of a person, the age of the person can be missing.

Features can also have data types. For instance, a feature can have a numerical data type, a free text data type, a categorical data type, or any other kind of data type. In the above example, the feature of age can be a numerical data type. In general, a feature's data type is categorical if the set of values that can be assigned to the feature is finite.

As referred to herein, “feature impact” of a feature can be a value (e.g., a score) indicating the feature's contribution to the predictions generated by a computer-implemented model. For example, the feature of a person's age can be determined to greatly contribute to a computer-implemented model's prediction of the person's healthcare spending. Feature impact for a computer-implemented model can be indicated in any format. For example, feature impact for a computer-implemented model can be indicated in a graphical representation and/or in a ranked list. In general, feature impact of a particular feature for a computer-implemented model can be determined by comparing predictions made by the computer-implemented model when values for the feature are neutralized with predictions made by the computer-implemented model when values for the feature are not neutralized. The greater the difference in predictions made by the computer-implemented model, the greater the impact of the feature on the predictions of the computer-implemented model. U.S. Publication No. US 2018/0060738 describes determination of feature impact (e.g., “feature importance”) for features of a computer-implemented model in further detail.

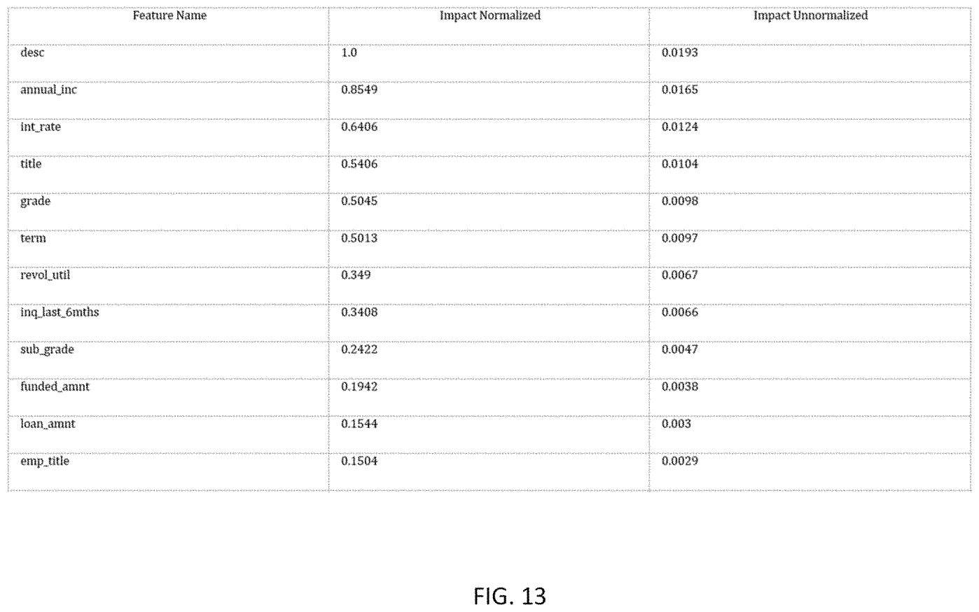

FIGS. 13-18 depict exemplar synthetic content for a specific example in which a computer-implemented model predicts loan default rates for bank customers based on features that may impact the likelihood of loan default (e.g., bank customers' annual income, loan interest rate, loan term, etc.).

FIG. 13 is a graphical representation of a table depicting an exemplar set of features included in data samples on which a computer-implemented model bases predictions, in accordance with an embodiment. Both a normalized feature impact score and a non-normalized feature impact score are depicted for each feature. To determine the normalized feature impact score for each feature, the feature impact score for the feature may be normalized to the highest feature impact score—in this case the feature impact score for the feature labeled as “desc”. Additionally, the features in the example FIG. 13 are ranked according to feature impact.

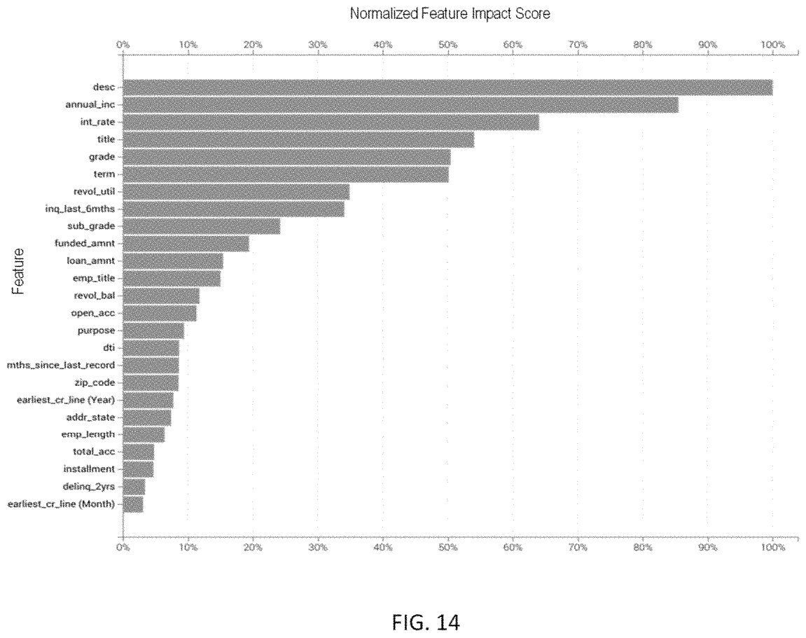

FIG. 14 is an exemplar graphical representation of the normalized feature impact scores for the features of FIG. 13 having the highest feature impact scores, in accordance with an embodiment.

Another example of synthetic content is an indication of feature effect. As referred to herein, “feature effect” of a feature of a data sample can be an indication (e.g., a score) of the feature's value's contribution to a prediction generated by a computer-implemented model based on the data sample. In other words, “feature effect” measures the contribution of a particular value of a feature of a data sample to a prediction generated by a computer-implemented model based on the data sample, while “feature impact” measures the contribution of the feature itself to the prediction generated by the computer-implemented model based on the data sample. In some embodiments, feature effect can be determined based on a partial dependence plot. A partial dependence plot depicts an average partial correlation between values of a feature of data samples and a prediction made by a computer-implemented model based on the data samples. Feature effect can be indicated in any format. For example, feature effect can be indicated in a graphical representation, e.g., a partial dependence plot, and/or in a ranked list.

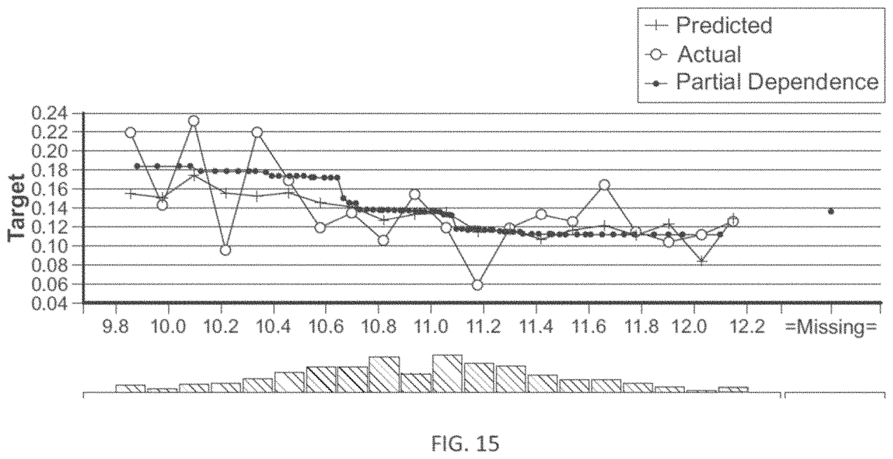

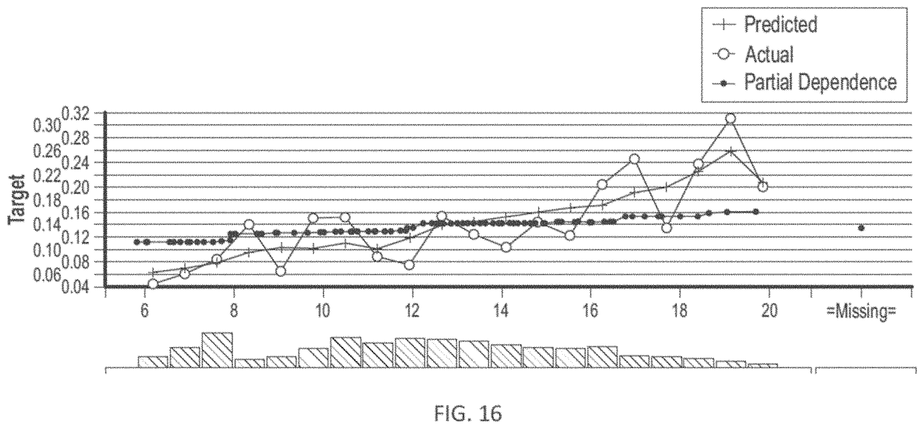

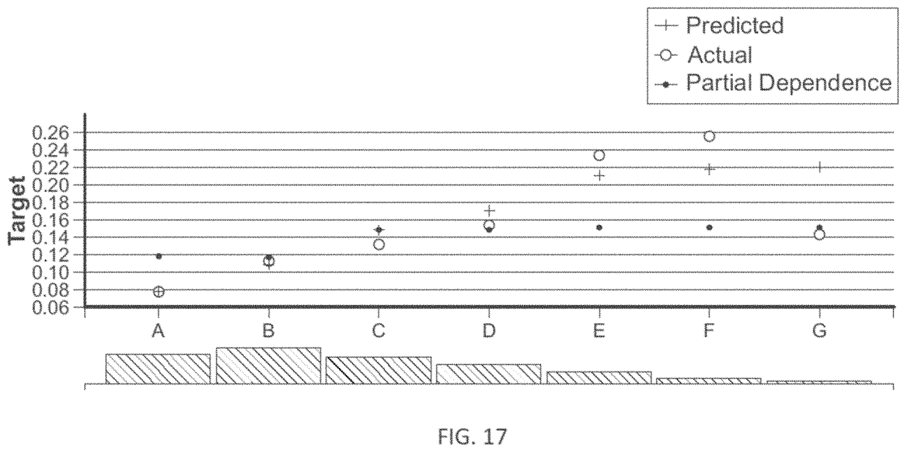

FIGS. 15-17 depict partial dependence plots for features of FIGS. 13 and 14, in accordance with an embodiment. Specifically, FIG. 15 is a partial dependence plot for the feature of FIGS. 13 and 14 labeled as “annual inc” (annual income), in accordance with an embodiment. FIG. 16 is a partial dependence plot for the feature of FIGS. 13 and 14 labeled as “int rate” (interest rate), in accordance with an embodiment. FIG. 17 is a partial dependence plot for the feature of FIGS. 13 and 14 labeled as “grade”, in accordance with an embodiment. In FIGS. 15-17, the lines labeled as “partial dependence” depict the marginal effect of the values of the given feature on the value to be predicted, after accounting for the average effects of all other predictive features. In other words, the line labeled as “partial dependence” indicates how the values of the given feature affect predictions of the computer-implemented model when all other variables are held constant. (For reference, in FIGS. 15-17, the line labeled as “actual” depicts average actual values for aggregated values of the given feature. The line labeled as “predicted” depicts average predictions by a computer-implemented model for specific values of the given feature. The bars under the x-axis represent a number of samples of the data set used to generate the line labeled as “actual” in which the feature of interest has the value corresponding to the portion of the x-axis above the bar. So, it's a histogram of the values of the feature of interest. By comparing the average actual values (shown in the line labeled as “actual”) with the average predictions (shown in the line labeled as “predicted”) for values of the given feature, deviations between the computer-implemented model's predictions and the actual targets at particular values of the given feature can be identified.)

Another example of synthetic content is an indication of feature fit of a computer-implemented model for one or more values of a feature of a data sample. As referred to herein, “feature fit” of a computer-implemented model for one or more values of a feature of a data sample can be an indication (e.g., a score) of performance of the computer-implemented model at generating predictions for the one or more values of the feature. Feature fit of a computer-implemented model identifies blind spots of the computer-implemented model for particular values of a feature. Feature fit for a computer-implemented model can be visualized in a partial dependence plot for the computer-implemented model, e.g., the partial dependence plots described above with regard to FIGS. 15-17. Specifically, feature fit of a computer-implemented model for a particular value of a feature can be visualized as the gap between the actual value of the feature and the predicted value of the feature. A smaller gap between the actual value of the feature and the predicted value of the feature indicates a better feature fit of the computer-implemented model for the value of the feature.

Another example of synthetic content is a feature associations matrix. A feature associations matrix depicts strengths of associations between pairs of numerical and categorical features of data samples. A feature associations matrix can be provided in any format. For example, a feature associations matrix can be provided in a graphical representation and/or in a ranked list.

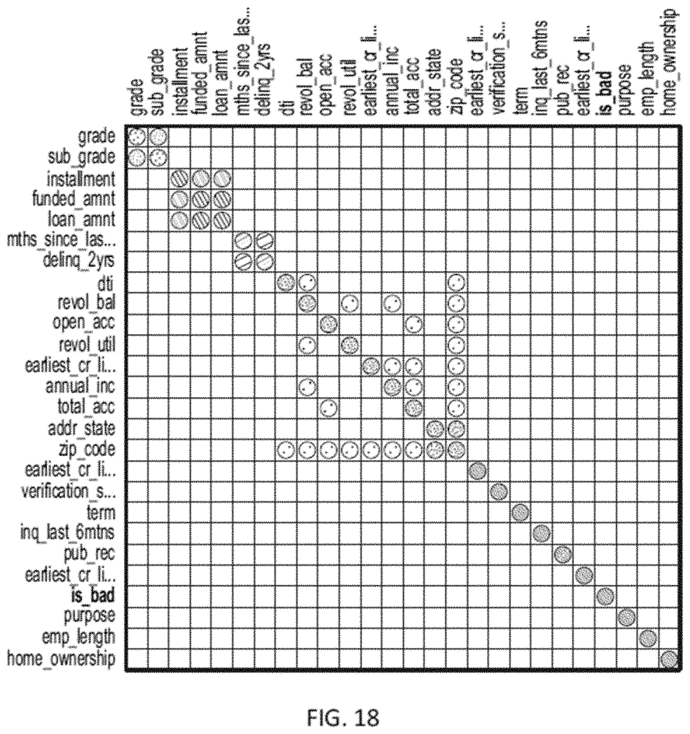

FIG. 18 is an exemplar graphical representation of a feature associations matrix, in accordance with an embodiment. The exemplar feature associations matrix depicted in FIG. 18 includes 26 features. Each of the 26 features is listed on both the x-axis and the y-axis of the feature associations matrix. Each pair of features intersects at a point within the feature associations matrix, and each feature intersects with itself along the matrix diagonal. The intersection of a pair of associated features within the feature associations matrix is indicated by a dot. An opacity of the dot provides an indication of a strength of association between the pair of features. Greater opacity indicates a weaker strength of association, and lesser opacity indicates a stronger strength of association. The strength of association between a pair of features can be assessed in accordance with any suitable metric, e.g., mutual information (“information gain”), Cramer's V, etc. Dots indicating pairs of features within the feature associations matrix are also clustered within the feature associations matrix according to the strength of the association. A cluster of feature pairs is indicated by a common color of the dots indicating the feature pairs. A gray-colored dot indicates that the pair of features show some association to one another, but are not in the same cluster. A white-colored dot indicates that a feature is not included in any cluster.

Another example of synthetic content is a description of feature engineering and/or feature selection operations performed during development of a computer-implemented model. As referred to herein, the term “feature engineering” with regard to a feature of data samples used by a computer-implemented model to generate predictions may refer to operations that transform the feature and/or the values of the feature to better represent a prediction problem represented by the data samples and solved by the computer-implemented model, with the goal of improving prediction performance of the computer-implemented model. As referred to herein, the term “feature selection” with regard to features of data samples used by a computer-implemented model to generate predictions may refer to selection of features and/or feature values for inclusion in the data samples. For example, feature selection may include imputing values to replace missing values of features of data samples, excluding features from data samples for one or more reasons related to, for example, low feature impact and target value leakage, and/or any feature selection operations.

Another example of synthetic content is an explanation of a prediction generated by a computer-implemented model. As used herein, the term “explanation” with regard to a prediction made by a computer-implemented model refers to a human-understandable articulation of one or more factors that contributed to the generation of the prediction by the computer-implemented model. For example, an explanation of a prediction generated by a computer-implemented model may be a sentence describing a rationale for the prediction. In general, an explanation of a prediction generated by a computer-implemented model may be based on feature impact of the features on which the prediction was based. The greater the feature impact, the greater the ability of the feature to explain the computer-implemented model prediction. International Application No. PCT/US19/66296 describes generation of computer-implemented model prediction explanations in further detail.

Another example of synthetic content is any of the above synthetic content generated for different versions of a computer-implemented model. Different versions of a computer-implemented model may have been trained using different sets of training data samples.

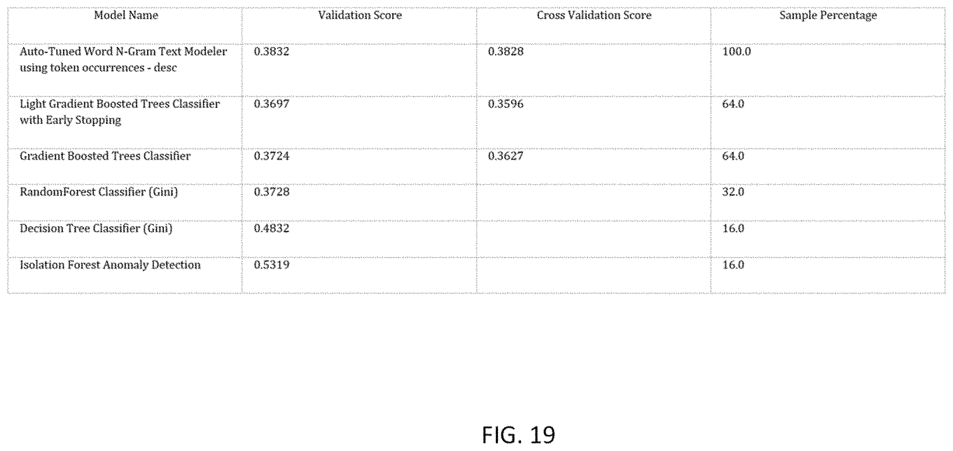

Another example of synthetic content is any of the above synthetic content generated for benchmark models of a computer-implemented model. FIG. 19 is a table depicting exemplar validation performance scores, cross-validation performance scores, and sample percentages generated for a plurality of benchmark models, in accordance with an embodiment. In the embodiment depicted in FIG. 19, the performance scores were generated according to a Log-Loss performance metric. This performance data for the benchmark models can be compared to performance data for a computer-implemented model to determine a relative performance of the computer-implemented model.

The above examples of synthetic content are examples only, and are not exhaustive. Any suitable data that is not stored in computer-readable form prior to initiation of documentation for the computer-implemented model, but rather is generated during the computer-implemented model documentation process by automatically performing one or more computations based on the computer-implemented model and one or more datasets can also be examples of synthetic content.

II.A.3. Instructional Text

As discussed in detail above, during documentation of a computer-implemented model using a documentation template, static and/or synthetic content placeholders of the documentation template can be automatically populated with content to generate the computer-implemented model documentation. However, in some embodiments, content that is subjective and/or that incorporates human knowledge can also be included computer-implemented model documentation. In such embodiments, unlike static and synthetic content, this subjective content may not be automatically populated within the documentation template. Rather, in such embodiments, such content can be added to the computer-implemented model documentation in response to user input.

To prompt a user to add content to computer-implemented model documentation, instructional text can be included within sections of the documentation template. Instructional text within a documentation template can provide insights and/or instructions regarding the computer-implemented model documentation process, for viewing by a user in the computer-implemented model documentation. For instance, instructional text can request that a user add content that is subjective and/or that incorporates human knowledge into the computer-implemented model documentation.

As an example, instructional text within a computer-implemented model documentation template can read: “Describe the model's purpose and its intended business use. Describe all stakeholders of this model, including their role, line-of-business, and team. This should include stakeholders of model ownership, model development, model implementation, and model risk management.” Then, when a user views this instructional text within computer-implemented model documentation, the user can follow these instructions and add content to the documentation accordingly.

One example of instructional text is a request for information describing a computer-implemented model's purpose and intended use cases.

Another example of instructional text is a request for information describing stakeholders of a computer-implemented model, including the role, line of business, and team of each stakeholder.

Another example of instructional text is a request for information describing how a computer-implemented model will interact with other computer-implemented models. For instance, the information may describe whether additional computer-implemented models are upstream or downstream of the computer-implemented model.

Another example of instructional text is a request for information describing how data samples processed by a computer-implemented model are suitable and relevant to intended use cases for the computer-implemented model. This information may include a description of how and from where the data samples were obtained.

Another example of instructional text is a request for information describing any weakness and limitations of data samples used to train a computer-implemented model, as well as how these weaknesses and limitations may impact the computer-implemented model.

Another example of instructional text is a request for information describing and justifying selection of features for inclusion in data samples processed by a computer-implemented model.

The above examples of instructional text are examples only, and are not exhaustive. Any other data that adhere to the definition of instructional text provided herein can also be examples of instructional text.

II.B. Model Documentation Template Creation

As discussed in detail above, computer-implemented model documentation is often subject to many different documentation guidelines, which can frequently change based on changing regulations. For example, in the banking industry, documentation templates are often controlled by governance policies that dictate the nature of the content to be included in the documentation templates. When these governance policies change, the documentation templates can be updated accordingly. To facilitate efficient compliance with these frequently changing regulations, it is important that users of the computer-implemented model documentation system are able to easily create new and edit existing documentation templates.

Existing documentation templates can be edited by a user of the computer-implemented model documentation system via a graphical user interface of the computer-implemented model documentation system. New documentation templates can also be created by a user of the computer-implemented model documentation system via the graphical user interface of the computer-implemented model documentation system. Specifically, via the graphical user interface of the computer-implemented model documentation system, a user can add and/or delete sections of a documentation template, rename existing sections of a documentation template, re-order sections of a documentation template, add static and/or synthetic content placeholders to sections of a documentation template, and/or add instructional text to a documentation template.

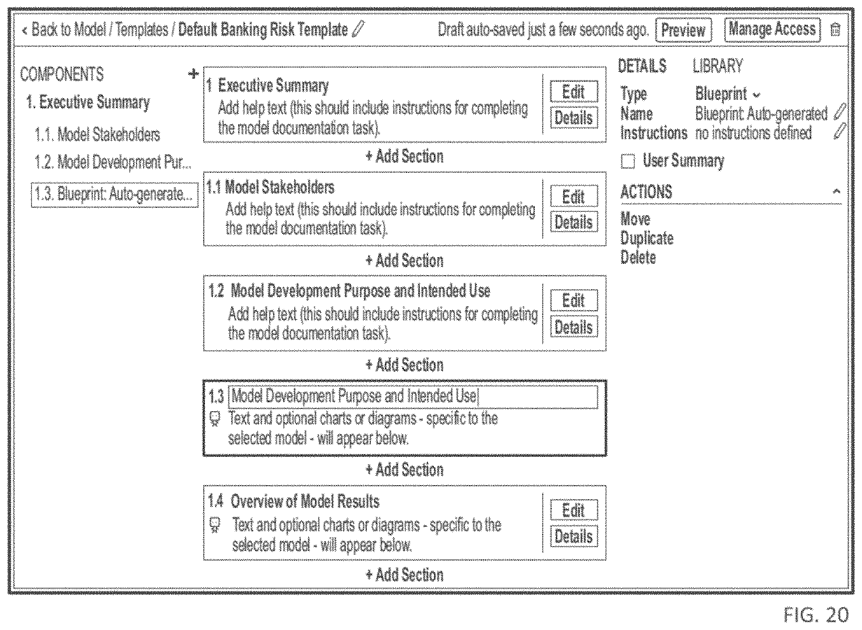

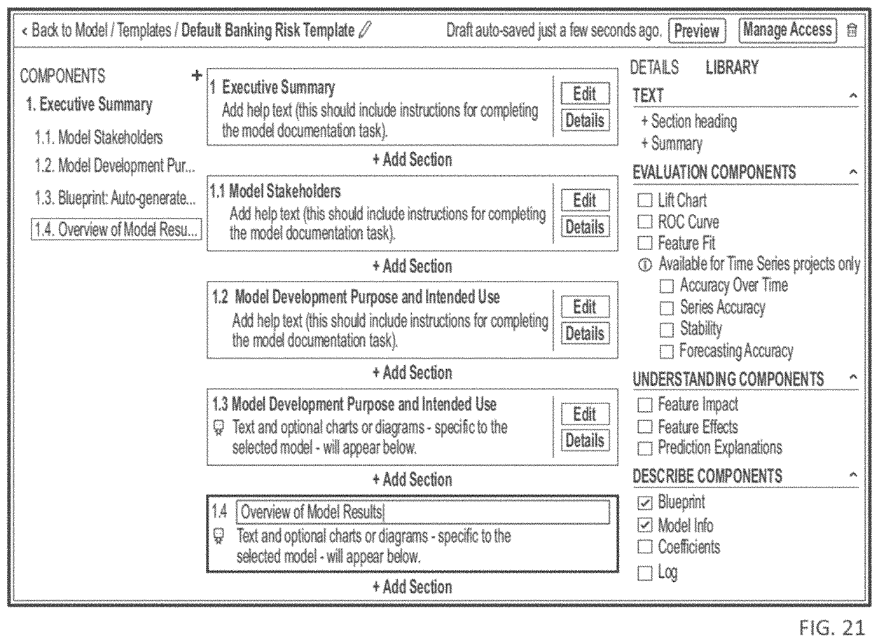

FIG. 20 is a screen shot of an example graphical user interface of a computer-implemented model documentation system, in accordance with an embodiment. Specifically, FIG. 20 is a screen shot of an example graphical user interface (GUI) of a computer-implemented model documentation system configured to control a process of creating a new documentation template for documenting a computer-implemented model configured to predict banking risk by presenting options and receiving inputs related to that process. In the example of FIG. 20, the user is adding a title of “Model Development Purpose and Intended Use” to section 1.3 of the documentation template via the GUI. When creating the documentation template, the user can also add sections, add static and/or synthetic content placeholders, and add instructional text to the documentation template via the GUI. The user can also add and/or edit section titles and reorder sections within the documentation template via the GUI.

FIG. 21 is a screen shot of another example graphical user interface of a computer-implemented model documentation system, in accordance with an embodiment. Specifically, FIG. 21 is a screen shot of another example graphical user interface (GUI) of a computer-implemented model documentation system configured to control a process of creating a new documentation template for documenting a computer-implemented model configured to predict banking risk. In the example of FIG. 21, the user is adding a title of “Overview of Model Results” to section 1.4 of the documentation template via the GUI. Additionally, as shown on the right-hand side of the screen shot in FIG. 21, the user is able to add static and/or synthetic content placeholders to section 1.4 of the documentation template via the GUI. An example of a static content placeholder that can be added to section 1.4 of the documentation template includes a placeholder for summary text. Examples of synthetic content placeholders that can be added to section 1.4 of the documentation template include placeholders for a lift chart and for prediction explanations.

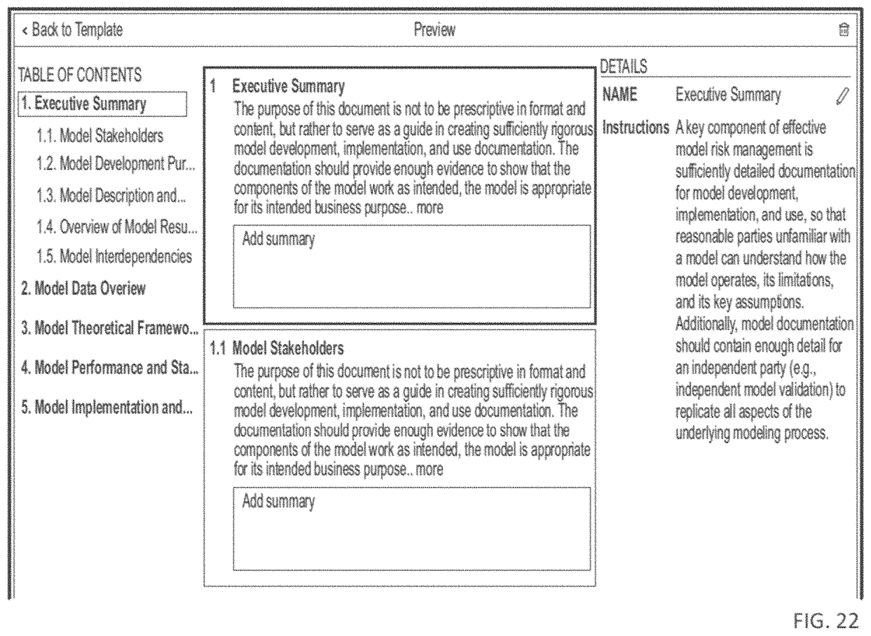

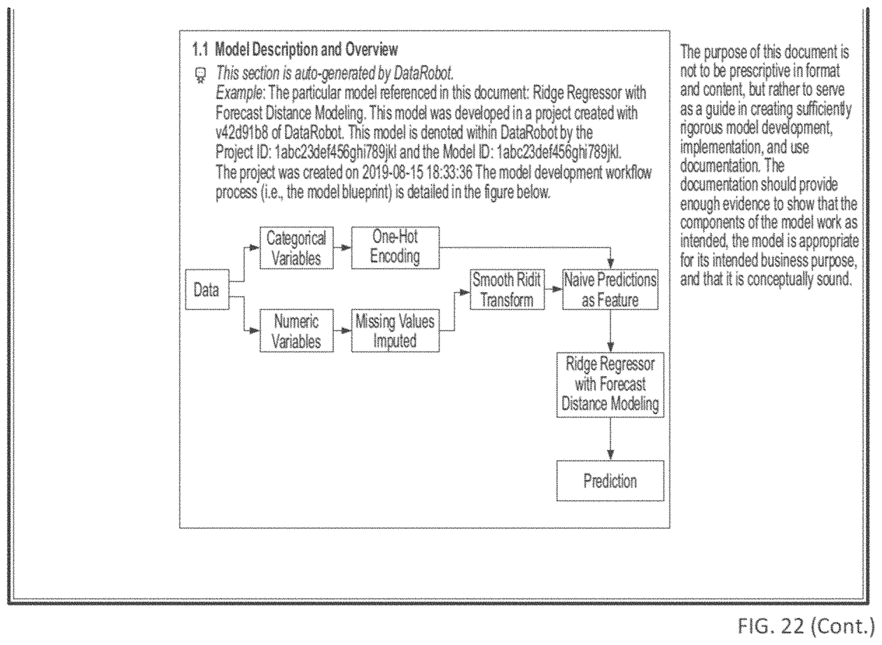

FIG. 22 is a screen shot of another example graphical user interface of a computer-implemented model documentation system, in accordance with an embodiment. Specifically, FIG. 22 is a screen shot of an example graphical user interface (GUI) of a computer-implemented model documentation system configured to present a preview of a documentation template that has been created for documenting a computer-implemented model configured to predict banking risk. In the example of FIG. 22, the documentation template includes instructional text that provides insights and/or instructions regarding the computer-implemented model documentation process. For example, the instructions listed for the “Executive Summary” section of the documentation template provide insights as to the purpose of the computer-implemented model documentation process. As another example, the “Model Description and Overview” section of the documentation template provides an example of synthetic content that will automatically populate this section during the computer-implemented model documentation process.

II.C. Model Documentation Template Management

As discussed in detail above, particularly in large organizations maintaining hundreds or thousands of computer-implemented models, utilization of documentation templates in documentation of computer-implemented models enables a more standardized and efficient model documentation process. As discussed above with regard to FIG. 2, these documentation templates can be stored in and accessed from a documentation template store. However, to enhance the benefits conferred by documentation templates, it is important that users of the computer-implemented model documentation system are able to easily identify and access the appropriate documentation templates from the documentation template store.

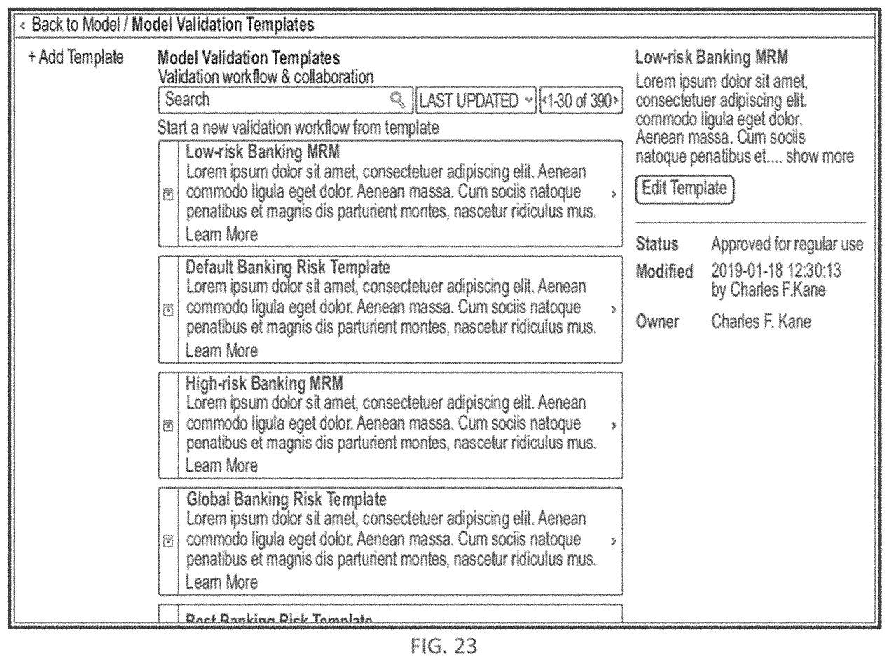

To improve ease of access to documentation templates within the documentation template store, users of the computer-implemented model documentation system can manage documentation templates stored in the documentation template store via the graphical user interface of the system. FIG. 23 is a screen shot of an example graphical user interface of a computer-implemented model documentation system, in accordance with an embodiment. Specifically, FIG. 23 is a screen shot of an example graphical user interface of a computer-implemented model documentation system which displays a list of computer-implemented model documentation templates stored in a computer-implemented model documentation template store. In the example of FIG. 23, the graphical user interface provides search inputs whereby a user can search for and manage particular documentation templates. Specifically, via the graphical user interface, users are able to select and edit existing documentation templates, duplicate existing documentation templates, and/or add new documentation templates. Via the graphical user interface users can also assign other users and/or groups of users to documentation templates within the documentation template store, manage user access to documentation templates within the documentation template store, and/or share documentation templates within the documentation template store with other users and/or groups of users. In this way, ease of access to documentation templates is improved.

II.D. Automated Model Documentation

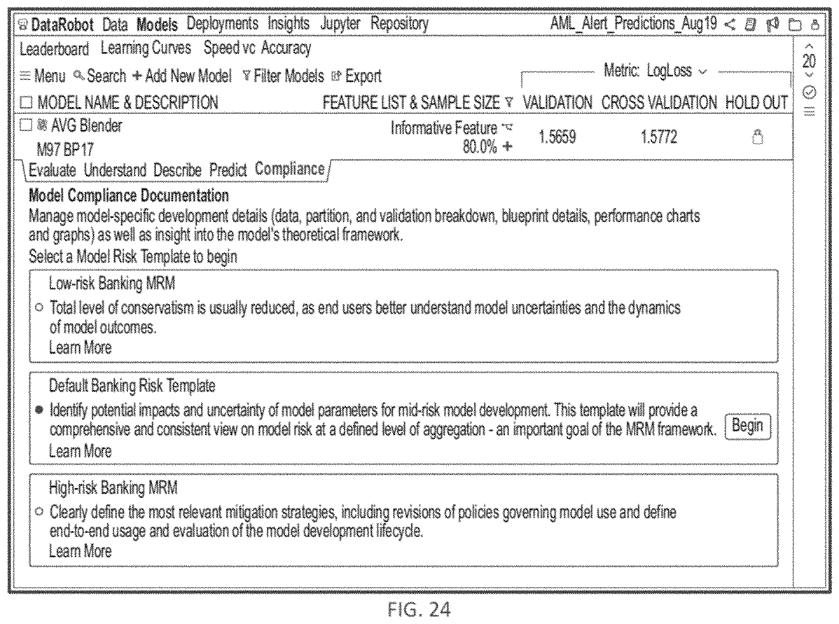

As discussed above, to perform automatic documentation of a computer-implemented model via the computer-implemented model documentation system, a user can select the computer-implemented model and a documentation template via a graphical user interface of the system. FIG. 24 is a screen shot of an example graphical user interface (GUI) of a computer-implemented model documentation system, in accordance with an embodiment. Specifically, FIG. 24 is a screen shot of an example graphical user interface of a computer-implemented model documentation system which displays available documentation templates and receivers user input indicating selection of a documentation template for automatic documentation of a computer-implemented model. In the example of FIG. 24, the user has selected a documentation template titled “Default Banking Risk Template” for automatic documentation of a computer-implemented model titled “AVG Blender.” The GUI controls the system to commence the automated documentation process for the AVG Blender model using the Default Banking Risk Template when the user selects “Begin” within the graphical user interface.

Following selection of a documentation template for automatic documentation of a computer-implemented model as shown in FIG. 24, but prior to initiation of the automatic documentation, a user can augment the selected documentation template with additional information. Specifically, a user can review and, if necessary, respond to instructional text within the selected documentation template by adding content to the documentation template. Alternatively, the user can respond to instructional text within the generated documentation itself.

As discussed in detail above, during automatic documentation of the computer-implemented model, the computer-implemented model documentation system automatically populates static and/or synthetic content placeholders within the selected documentation template with static and/or synthetic content, respectively. In some embodiments, automatic population of the content placeholders within the selected documentation template can be achieved using metadata tags. This automatic population of the content placeholders within the selected documentation template automatically generates documentation for the computer-implemented model. This documentation can be exported into many supported formats including, for example, .doc, .pdf, .ppt, .htm1, .htm15, .txt, and .tex (LaTeX) formats. Finally, the documentation can be reviewed and optionally edited by a user.

### III. Benefits of Automated Model Documentation

As discussed throughout this disclosure, there are many benefits to utilizing some embodiments of the computer-implemented model documentation system disclosed herein to automatically document computer-implemented models, as opposed to utilizing traditional and largely manual methods of documentation. Briefly, some of these benefits are as follows:
1. Expedited computer-implemented model documentation submission and approval;
2. improved allocation of the time of highly-compensated technical resources (e.g., data scientsists);
3. more accurate, complete, and standardized computer-implemented model documentation;
4. simplified compliance with changing computer-implemented model regulations;
5. improved organization of computer-implmented models and corresponding documentation;
6. improved coordination between computer-implemented model development and documentation; and
7. simpler collaboration between computer-implemented model developers, peer reviwers, and/or auditors.

### IV. Example Use Cases

In this section, some non-limiting examples of applications of some embodiments of automated computer-implemented model documentation are described. In Section IV.A, an example of using automated computer-implemented model documentation to document development of banking models is described. In Section IV.B, an example of using automated computer-implemented model documentation to document validation of banking models is described. In Section IV.C, an example of using automated computer-implemented model documentation to document insurance pricing models is described. In Section IV.D, an example of using automated computer-implemented model documentation to report modeling results is described.

IV.A. Example 1: Banking Model Development

Many banks are required by regulators (e.g., SR11-7 in the United States) to implement processes that provide an “effective challenge” to the computer-implemented models that they build, regardless of the application, criticality, or complexity of the computer-implemented models. In response to such regulation, banks have formed model governance teams that operate independently from model development teams. To gain approval to use a computer-implemented model, the model development team carefully document their work such that the model governance team can reproduce the model development team's analysis using only the documentation provided. Therefore, the model documentation tends to be detailed, highly technical, and complete. As a result, the model documentation process can consume hundreds of human hours. Furthermore, large banks can maintain several thousand models, which are collectively documented by many tens of thousands of pages of documentation. The format and content of model documentation can vary from bank to bank based on internal requirements, the type of model, the application, model risk, and model criticality. For example, more complex and critical models may require more intense scrutiny prior to approval. Once a model is documented, the model development team delivers the model and the documentation to the model governance team for inspection and replication.

Thus the automated computer-implemented model documentation system described herein could be readily implemented in the banking industry to replace the current complex, costly, and inefficient process for documentation of banking model development.

IV.B. Example 2: Banking Model Validation

Following production of model documentation, the model governance team can evaluate the model development process described in the model documentation, and prepare a report including evaluation details, comments, and questions. Following preparation of this report, either the report is provided to the model development team with instructions to implement changes to the model, the model is approved outright, or the model is approved provisionally. Provisional approval of the model implies that additional model validation is required. This report prepared by the model governance team may be standardized.

Thus the automated computer-implemented model documentation system described herein could also be implemented in preparation of standardized banking model validation reports.

IV.C. Example 3: Insurance Pricing Model Filings

Insurance companies in the United States may be required to file proposed insurance pricing models with each state department of insurance. These insurance filings are lengthy and complex. Additionally, these insurance filings may be required to comply with a standardized process that varies state by state. Making changes to insurance pricing models is an expensive process, primarily due to the expense of separately preparing and filing the pricing models in 50 different states, each having a different standardized process. However, despite the state by state differences in insurance pricing model filing requirements, many of the filing requirements are the same, but are simply ordered or organized differently. Thus the automated computer-implemented model documentation system and its use of documentation templates described herein can be implemented to prepare insurance pricing model filings much more efficiently and inexpensively.

IV.B. Example 4: Model Results Reporting

Consulting firms and data science teams build many different computer-implemented models for many different stakeholders. However, the process of describing and evaluating the models is largely the same. Thus the automated computer-implemented model documentation system described herein could be implemented to standardize diverse model documentation for presentation to diverse stakeholders.

### V. Example Computer

In some examples, some or all of the processing described above can be carried out on a personal computing device, on one or more centralized computing devices, or via cloud-based processing by one or more servers. In some examples, some types of processing occur on one device and other types of processing occur on another device. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, e.g., flash-based memory, can be used.

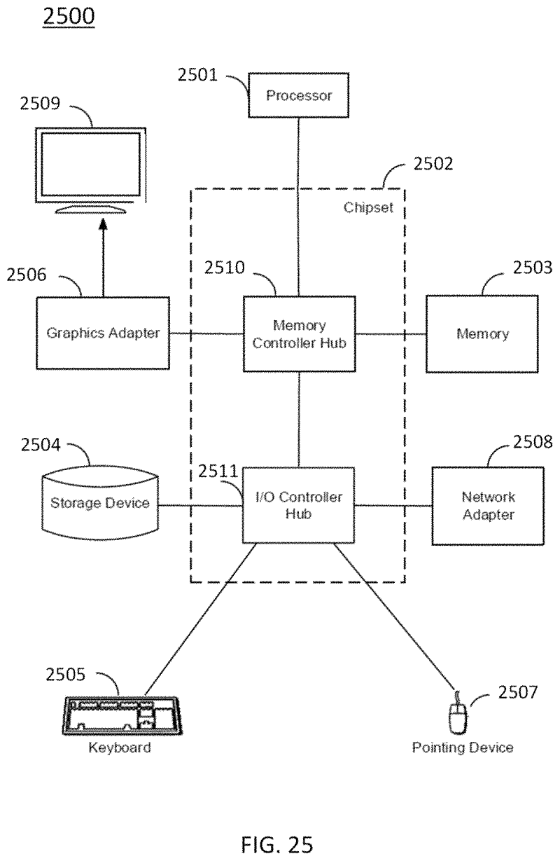

FIG. 25 illustrates an example computer 2500 for implementing the methods described herein (e.g., in FIGS. 1-25), in accordance with an embodiment. The computer 2500 includes at least one processor 2501 coupled to a chipset 2502. The chipset 2502 includes a memory controller hub 2510 and an input/output (I/O) controller hub 2511. A memory 2503 and a graphics adapter 2506 are coupled to the memory controller hub 2510, and a display 2509 is coupled to the graphics adapter 2506. A storage device 2504, an input device 2507, and network adapter 2508 are coupled to the I/O controller hub 2511. Other embodiments of the computer 2500 have different architectures.

The storage device 2504 is a non-transitory computer-readable storage medium, e.g., a hard drive, compact disk read-only memory (CD-ROM), DVD, or a solid-state memory device. The memory 2503 holds instructions and data used by the processor 2501. The input interface 2507 is a touch-screen interface, a mouse, track ball, or other type of pointing device, a keyboard, or some combination thereof, and is used to input data into the computer 2500. In some embodiments, the computer 2500 can be configured to receive input (e.g., commands) from the input interface 2507 via gestures from the user. The graphics adapter 2506 displays images and other information on the display 2509. The network adapter 2508 couples the computer 2500 to one or more computer networks.

The computer 2500 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 2504, loaded into the memory 2503, and executed by the processor 2501.

The types of computers 2500 used to implement the methods described herein can vary depending upon the embodiment and the processing power required by the entity. For example, the computer-implemented model documentation system can run in a single computer 2500 or multiple computers 2500 communicating with each other through a network, e.g., in a server farm. The computers 2500 can lack some of the components described above, e.g., graphics adapters 2506, and displays 2509.

### VI. Additional Considerations

The foregoing description of some embodiments of the invention has been presented for the purpose of illustration—it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Any of the steps, operations, or processes described herein can be performed or implemented with one or more hardware or software modules, alone or in combination with other devices. In one embodiment, a software module is implemented with a computer program product including a computer-readable non-transitory medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may include information resulting from a computing process, where the information is stored on a non-transitory, tangible computer-readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

1. A method for automatically generating documentation for a computer-implemented model, The method comprising:
receiving, via a graphical user interface, user input indicative of selection of the computer-implemented model;
receiving, via the graphical user interface, user input indicative of selection of a documentation template, the documentation template including synthetic content placeholders; and
automatically generating the documentation for the computer-implemented model, including:
automatically generating, by a computer processor, synthetic content for each of the synthetic content placeholders based on one or more characteristics of the computer-implemented model; and
automatically populating the synthetic content placeholders with the respective synthetic content.

2. The method of claim 1, wherein the computer-implemented model documentation is generated following development of the computer-implemented model.

3. The method of claim 1, wherein the computer-implemented model documentation is generated during development of the computer-implemented model.

4. The method of claim 1, wherein the documentation template is selected from a database storing a plurality of documentation templates.

5. The method of claim 1, wherein the documentation template comprises a new documentation template created by the user via the graphical user interface prior to selection, or comprises an existing documentation template edited by the user via the graphical user interface prior to selection, and wherein creation and editing of the documentation template at least in part comprise selection of at least one of the synthetic content placeholders for inclusion in the documentation template.

6. The method of claim 1, wherein the documentation template further includes static content placeholders, and wherein automatically generating the documentation for the computer-implemented model further comprises:
automatically identifying, by the computer processor, static content for each of the static content placeholders based on one or more characteristics of the computer-implemented model; and
automatically populating the static content placeholders with the respective static content.

7. The method of claim 1, wherein the synthetic content comprises validation and/or cross-validation performance scores for the computer-implemented model, and wherein automatically generating the synthetic content comprises automatically generating the validation and/or cross-validation performance scores for the computer-implemented model.

8. The method of claim 7, wherein automatically generating the validation and/or cross-validation performance scores for the computer-implemented model comprises:
generating the validation performance score for the computer-implemented model based on a proportion of correct predictions generated by the computer-implemented model on a portion of a training dataset held-out from training the computer-implemented model; and/or
generating the cross-validation performance score for the computer-implemented model based on a proportion of correct predictions generated by the computer-implmeneted model on each portion of a pluraity of portions of the training dataset used to train the computer-implemented model.

9. The method of claim 1, wherein the synthetic content comprises a list of features of data samples processed by the computer-model, wherein each feature in the list of features is ranked according to a respective feature impact score, and wherein automatically generating the synthetic content comprises automatically determining the respective feature impact score for each feature and automatically ranking the features in the list of features according to the determined feature impact scores.

10. The method of claim 9, wherein automatically determining the respective feature impact score for each feature comprises automatically determining a contribution of the feature to one or more predictions generated by the computer-implemented model.

11. The method of claim 1, wherein the synthetic content comprises text summarizing an explanation for predictions generated by the computer-implemented model, and wherein automatically generating the synthetic content comprises automatically generating the text.

12. The method of claim 11, wherein automatically generating the text summarizing the explanation for predictions generated by the computer-implemented model comprises:
automatically determining a respective feature impact score for each feature in a list of features of data samples processed by the computer-model, the respective feature impact score for each feature indicating a contribution of the feature to the predictions generated by the computer-implemented model; and
auotmatically generating text describing the respective feature impact score for each feature in the list of features.

13. A system for automatically generating documentation for a computer-implemented model, the system comprising:
a computer processor; and
a memory storing instructions which, when executed by the computer processor, causes the computer processor to:
receive, via a graphical user interface, user input indicative of selection of the computer-implemented model;
receive, via the graphical user interface, user input indicative of selection of a documentation template, the documentation template including synthetic content placeholders; and
automatically generate, by the computer processor, the documentation for the computer-implemented model, including:
automatically generate, by the computer processor, synthetic content for each of the synthetic content placeholders based on one or more characteristics of the computer-implemented model; and
automatically populate the synthetic content placeholders with the respective synthetic content.

14. The method of claim 13, wherein the computer-implemented model documentation is generated following development of the computer-implemented model.

15. The method of claim 13, wherein the computer-implemented model documentation is generated during development of the computer-implemented model.

16. The method of claim 13, wherein the documentation template is selected from a database storing a plurality of documentation templates.

17. The method of claim 13, wherein the documentation template comprises a new documentation template created by the user via the graphical user interface prior to selection, or comprises an existing documentation template edited by the user via the graphical user interface prior to selection, and wherein creation and editing of the documentation template at least in part comprise selection of at least one of the synthetic content placeholders for inclusion in the documentation template.

18. The method of claim 13, wherein the documentation template further includes static content placeholders, and wherein automatically generating the documentation for the computer-implemented model further comprises:
automatically identifying, by the computer processor, static content for each of the static content placeholders based on one or more characteristics of the computer-implemented model; and
automatically populating the static content placeholders with the respective static content.

19. The method of claim 13, wherein the synthetic content comprises validation and/or cross-validation performance scores for the computer-implemented model, and wherein automatically generating the synthetic content comprises automatically generating the validation and/or cross-validation performance scores for the computer-implemented model.

20. The method of claim 19, wherein automatically generating the validation and/or cross-validation performance scores for the computer-implemented model comprises:
generating the validation performance score for the computer-implemented model based on a proportion of correct predictions generated by the computer-implemented model on a portion of a training dataset held-out from training the computer-implemented model; and/or
generating the cross-validation performance score for the computer-implemented model based on a proportion of correct predictions generated by the computer-implmeneted model on each portion of a pluraity of portions of the training dataset used to train the computer-implemented model.

21.-36. (canceled)
